(19) United States
(12) Patent Application Publication
(10) Pub. No.: US 2025/0362532 A1
(43) Pub. Date: Nov. 27, 2025

(54) SEMICONDUCTOR PHOTONICS DEVICE AND METHODS OF FORMATION

(71) Applicant: Taiwan Semiconductor Manufacturing Company, Ltd., Hsinchu (TW)

(72) Inventors: Shu-Wei CHANG, Taipei City (TW); Chia-Hua CHU, Zhubei City (TW); Sheng Kai YEH, Taichung City (TW); Feng YUAN, Hsinchu City (TW); Chih-Tsung SHIH, Hsinchu City (TW); Chi-Yuan SHIH, Hsinchu (TW); Shih-Fen HUANG, Jhubei (TW)

(21) Appl. No.: 18/802,241

(22) Filed: Aug. 13, 2024

Related U.S. Application Data
(60) Provisional application No. 63/650,111, filed on May 21, 2024.

(51) Int. Cl. G02F 1/01

(52) U.S. Cl. CPC G02F 1/0147

(57) ABSTRACT

A heater element of a modulator heater structure includes a plurality of segments. The segments of the heater element may be arranged in various configurations that conform to, or that are different from, the shape of the optical modulator structure. The segments of the heater element increase the effective length of the heater element and reduces a cross-sectional area of a current flow path through the heater element. The combination of the increased length and reduced cross-sectional area increases the resistance of the heater element, which increases the thermal efficiency of the heater element. The increased thermal efficiency of the heater element enables the heater element to generate heat more efficiently. Thus, the increased thermal efficiency of the heater element enables the heater element to more efficiently stabilize the operating temperature of the optical modulator structure, which may increase the performance of the optical modulator structure.

### CROSS-REFERENCE TO RELATED APPLICATION

This Patent application claims priority to U.S. Provisional Patent Application No. 63/650,111, filed on May 21, 2024, and entitled “SEMICONDUCTOR PHOTONICS DEVICE AND METHODS OF FORMATION.” The disclosure of the prior Application is considered part of and is incorporated by reference into this Patent Application.

### BACKGROUND

A semiconductor photonics device may be configured to use optical signals for high speed and secure data transmission between integrated circuits and/or semiconductor dies of the semiconductor photonics device. An optical signal may be transferred through a waveguide in the semiconductor photonics device. The waveguide enables confinement of the optical signal, which may reduce optical loss and increase propagation efficiency for the optical signal. Data may be encoded into an optical signal by modulating light into optical pulses through an optical modulator. The optical pulses are then transferred to the waveguide for propagation to other regions of the semiconductor photonics device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C are diagrams of an example semiconductor photonics device described herein.

FIGS. 2A-2G are diagrams of an example implementation of forming a semiconductor photonics device described herein.

FIGS. 3A and 3B are diagrams of example implementations of a heater element of a modulator heater structure described herein.

FIGS. 4A-4E are diagrams of example implementations of alternative placement of a modulator heater structure described herein.

FIG. 5 is a diagram of an example implementation of a modulator heater structure described herein.

FIGS. 6A-6G are diagrams of example implementations of top view arrangements for an optical modulator structure and a heater element of an associated modulator heater structure described herein.

FIG. 7 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some cases, a photonic integrated circuit that includes a waveguide and an optical modulator structure may be included in a dielectric region of a semiconductor photonics device. The dielectric region may be located above a substrate of the semiconductor photonics device. The resonant wavelengths of the optical modulator structure may be sensitive to variations in processes and operating temperatures. Thus, a modulator heater structure may be included in the dielectric region to stabilize the operating temperature of the optical modulator structure (thereby stabilizing the operating performance of the optical modulator structure) and/or to modulate optical signals through the thermo-optic effect.

The modulator heater structure may include a heater element directly above the optical modulator. The heater element may be configured to receive and to dissipate an electrical current, thereby generating the heat that is used to heat the optical modulator structure. The heater element may be coupled with a distribution pad of the modulator heater structure. The distribution pad may be configured to provide the electrical current to the heater element (e.g., from one or more interconnect layer conductive structures).

The modulator heater structure may be a significant source of power consumption in a semiconductor photonics device. Thus, thermal inefficiencies in the modulator heater structure may further increase the power consumption of the semiconductor photonics device, thereby decreasing the power efficiency of the semiconductor photonics device. Moreover, thermal inefficiencies in the modulator heater structure may result in temperature drops in the optical modulator structure in that the thermal inefficiencies may result in temperature instability in the modulator heater structure.

In some implementations described herein, a waveguide structure and an optical modulator structure of a semiconductor photonics device are included in a dielectric region above a substrate of the semiconductor photonics device. A modulator heater structure is included to stabilize the operation of the optical modulator structure during operation by heating the optical modulator structure to a stabilized temperature. The modulator heater structure includes a heater element and a distribution pad electrically coupled to the heater element.

The heater element is a segmented heater element includes a plurality of segments as opposed to a solid heater element. The segments of the heater element may be arranged in various configurations that conform to, or that are different from, the shape of the optical modulator structure. The segments of the heater element increase the effective length of the heater element and reduces a cross-sectional area of a current flow path through the heater element. The combination of the increased length and reduced cross-sectional area increases the resistance of the heater element, which enables the heater element to dissipate current more efficiently than a solid heater element (e.g., increases the thermal efficiency of the heater element). The increased thermal efficiency of the heater element enables the heater element to heat up more quickly and to generate heat more efficiently than a solid heater element. Thus, the increased thermal efficiency of the heater element enables the heater element to more efficiently stabilize the operating temperature of the optical modulator structure, which may increase the performance of the optical modulator structure.

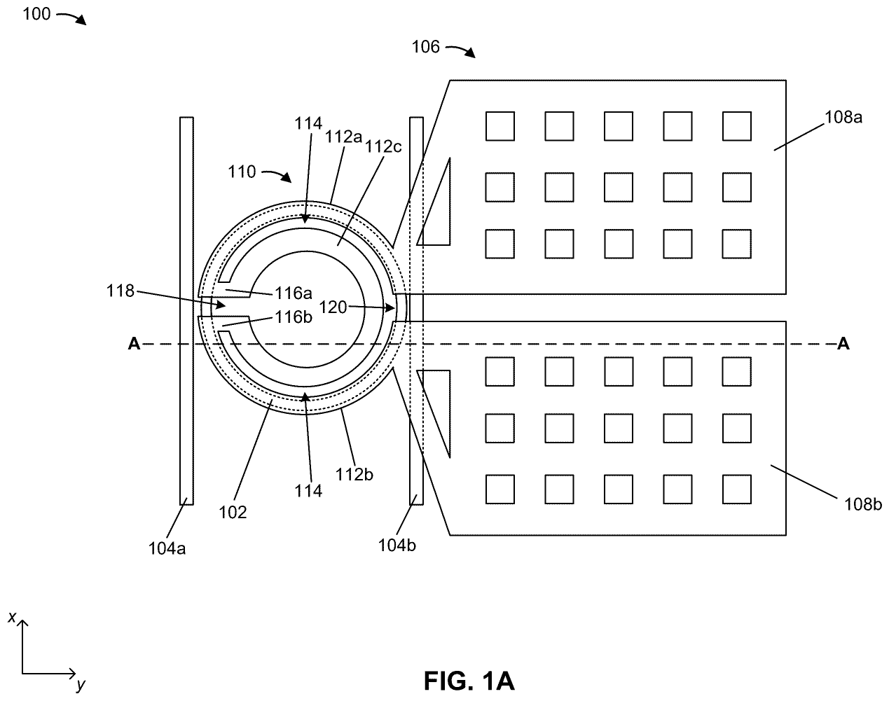

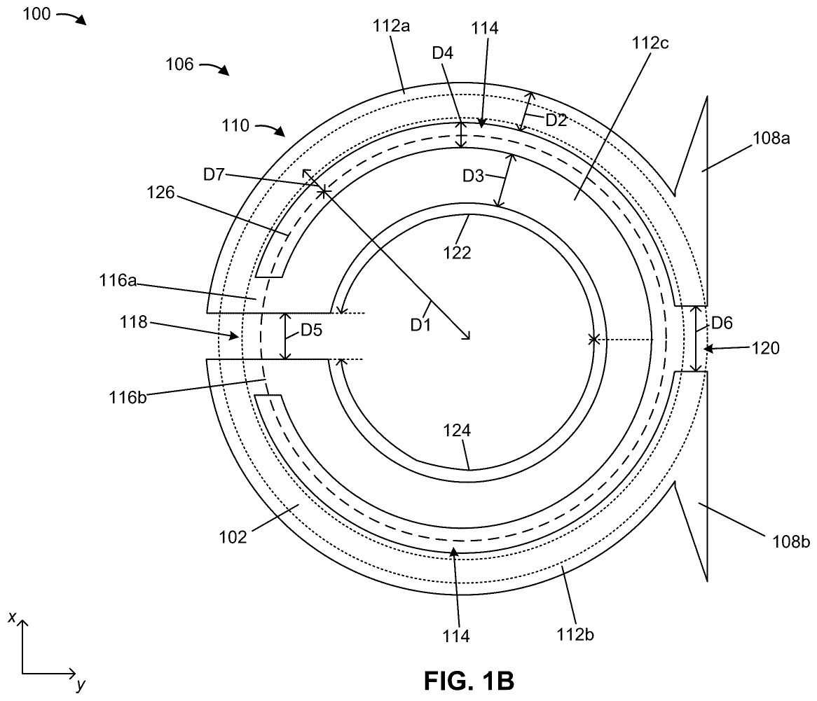

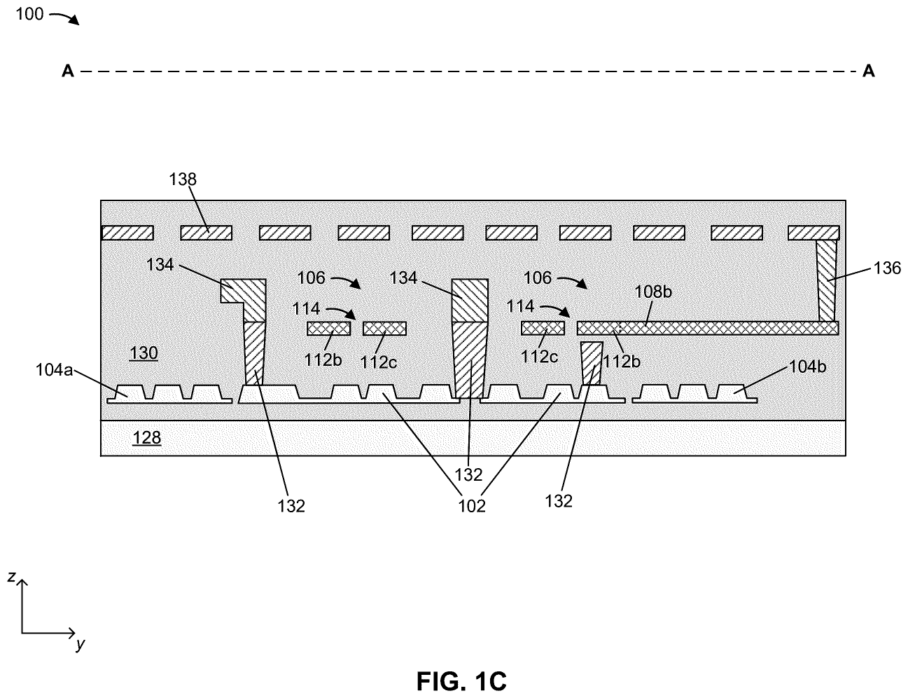

FIGS. 1A-1C are diagrams of an example semiconductor photonics device 100 described herein. FIG. 1A illustrates a top view of the semiconductor photonics device 100. As shown in FIG. 1A, the semiconductor photonics device 100 may include a photonic integrated circuit that includes an optical modulator structure 102 and one or more optical waveguide structures 104a and/or 104b, among other examples. The optical modulator structure 102 and the one or more optical waveguide structures 104a and/or 104b may be configured to receive optical signals, modulate optical signals, and/or provide modulated optical signals for high speed and secure data transmission between integrated circuits and/or semiconductor dies of the semiconductor photonics device 100 and/or between the semiconductor photonics device 100 and another device. In some implementations, the optical modulator structure 102 may be configured modulate optical signals in a wavelength range of approximately 1260 nanometers to approximately 1360 nanometers. However, other wavelengths and other wavelength ranges are within the scope of the present disclosure. In some implementations, the photonic integrated circuit of the semiconductor photonics device 100 includes additional optical components, such as a grating coupler, a polarizer, an optical resonator, an optical splitter, and/or a photodetector, among other examples.

As shown in FIG. 1A, the optical modulator structure 102 may include a closed-loop optical waveguide structure that may be located laterally between the optical waveguide structures 104a and 104b such that the optical waveguide structures 104a and 104b are located adjacent to opposing sides of the closed-loop optical waveguide structure of the optical modulator structure 102. As an example, and as shown in FIG. 1A, the optical modulator structure 102 and the optical waveguide structure 104a may be horizontally adjacent (or laterally adjacent) in the y-direction in the semiconductor photonics device 100, and the optical modulator structure 102 and the optical waveguide structure 104b may be horizontally adjacent (or laterally adjacent) in the y-direction in the semiconductor photonics device 100. The optical modulator structure 102 and the optical waveguide structures 104a and 104b may be adjacent and/or side by side in the semiconductor photonics device 100 to facilitate coupling of optical signals between the optical modulator structure 102 and the optical waveguide structures 104a and 104b.

The optical modulator structure 102 may be “closed-loop” in that the optical waveguide structure of the optical modulator structure 102 may be a continuous optical waveguide structure that connects to itself with no end points. This is different from other types of modulators and resonators such as Mach-Zender modulators (MZMs) that have end points corresponding to an input and an output. Instead of optical signals being coupled to and from an MZM through propagation of the optical signals through the input and output of the MZM, optical signals may be coupled to and from the optical modulator structure 102 through evanescent coupling. Evanescent coupling from the optical waveguide structure 104a (or from the optical waveguide structure 104b) and the optical modulator structure 102 occurs when the evanescent field of the optical signals propagating through the optical waveguide structure 104a (or from the optical waveguide structure 104b) extends into the portion of the optical modulator structure 102 that is adjacent to the optical waveguide structure 104a (or is adjacent to the optical waveguide structure 104b). Similarly, evanescent coupling from the optical modulator structure 102 to the optical waveguide structure 104a (or to the optical waveguide structure 104b) occurs when the evanescent field of the optical signals propagating through the optical modulator structure 102 extends into a portion of the optical waveguide structure 104a (or into a portion of the optical waveguide structure 104b).

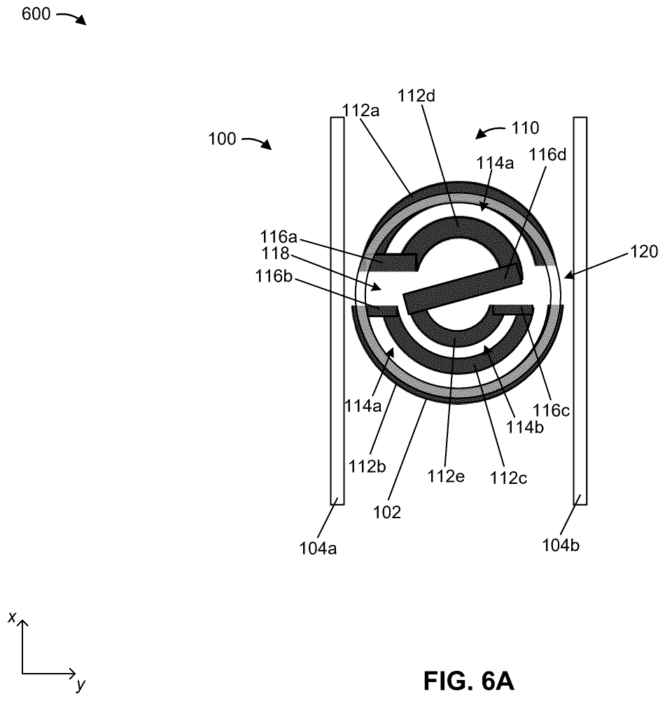

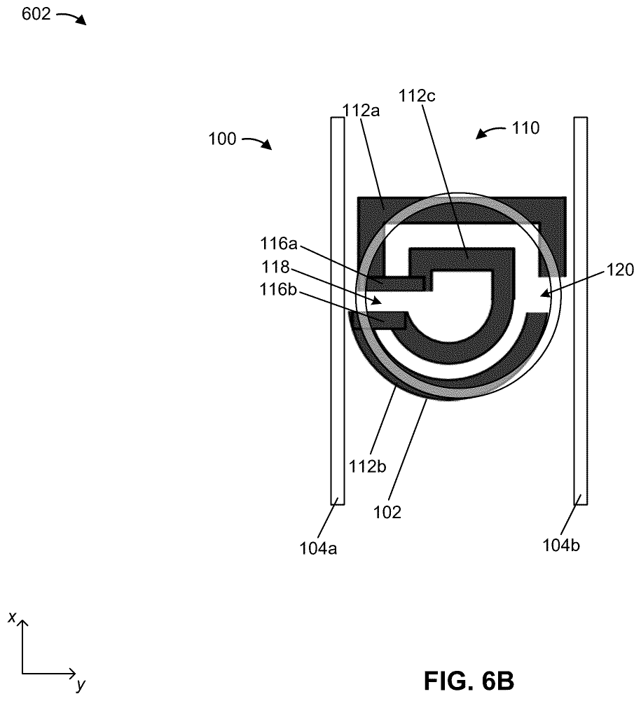

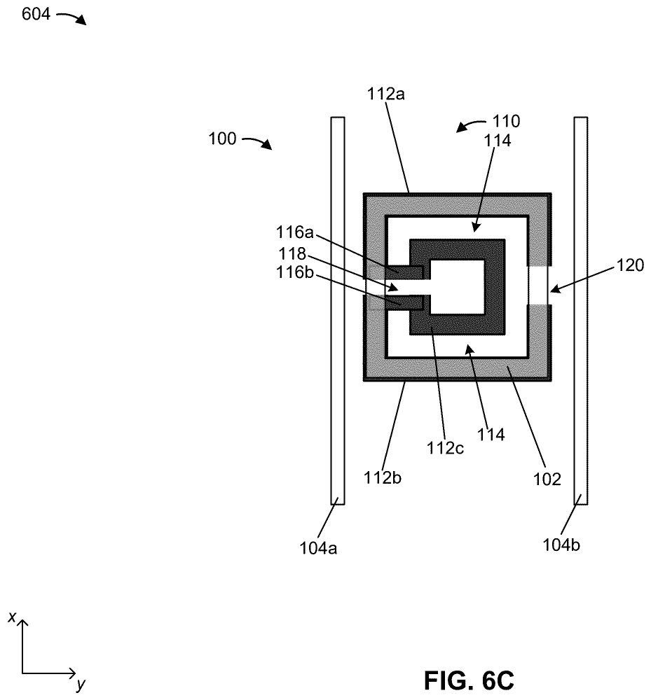

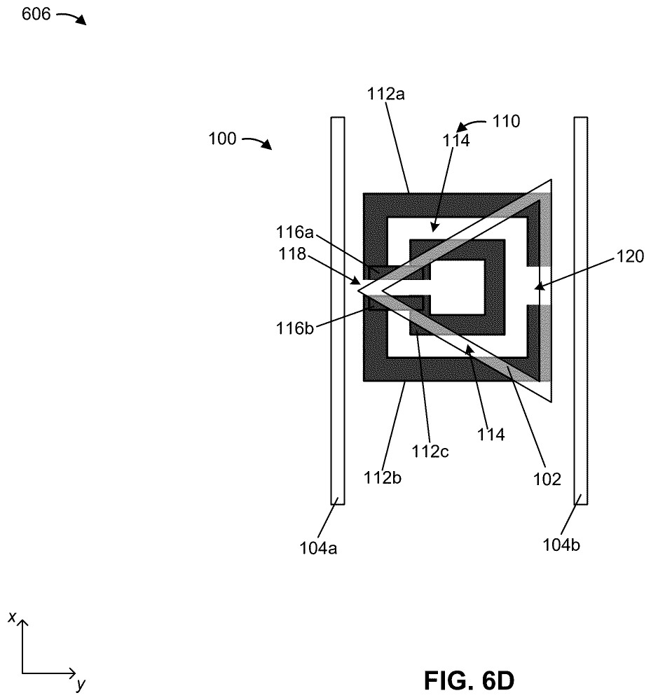

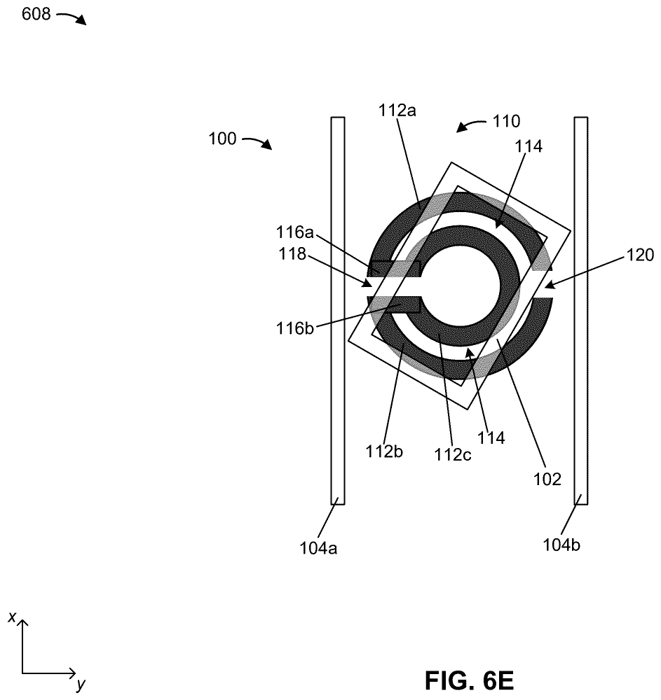

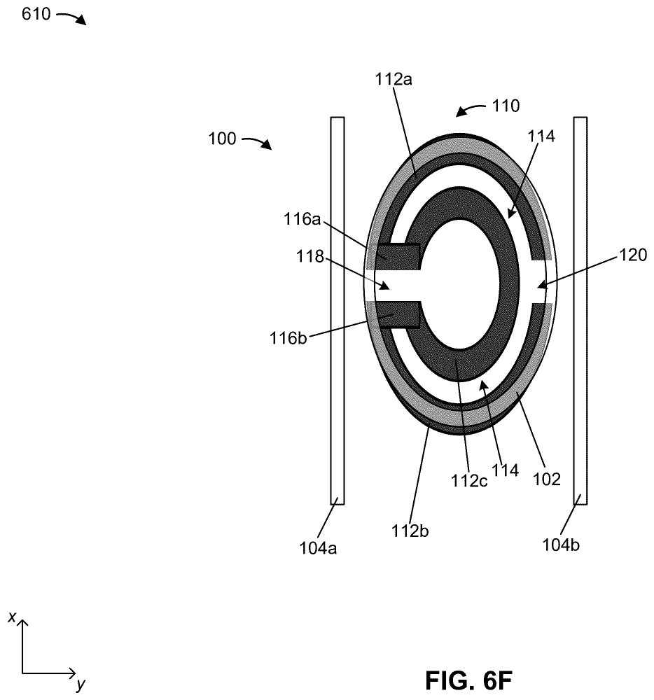

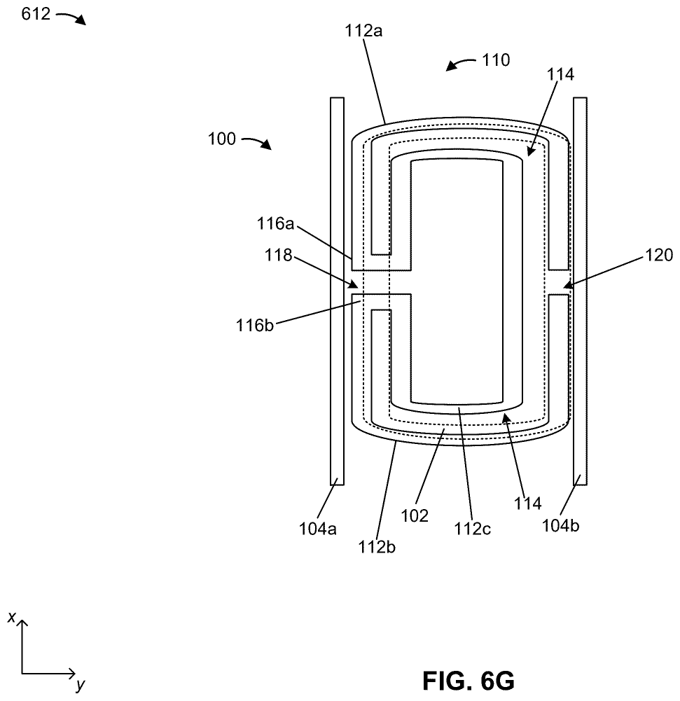

As shown in FIG. 1A, the optical modulator structure 102 may have an approximate ring top view shape. In some implementations, the optical modulator structure 102 may have another top view shape, such as one or more of the top view shapes illustrated in FIGS. 6A-6G, among other examples. Alternatively, the optical modulator structure 102 may be implemented as an MZM or another type of optical modulator structure.

The optical waveguide structures 104a and 104b may extend in the x-direction along opposing sides of the optical modulator structure 102. Optical signals may be transferred through the optical waveguide structure 104a in the semiconductor photonics device 100. The opposing ends of the optical waveguide structure 104a correspond to an input port and a through port (or output port) of the photonic integrated circuit. The optical waveguide structure 104a enables confinement of the optical signal, which may reduce optical loss and increase propagation efficiency for the optical signal. In some implementations, data may be encoded into an optical signal by modulating light into optical pulses in the optical modulator structure 102. The optical pulses are then transferred to the optical waveguide structure 104a for propagation to other regions of the semiconductor photonics device 100.

The optical waveguide structure 104b may be used for controlling or manipulating the optical resonant properties of the optical modulator structure 102. For example, the opposing ends of the optical waveguide structure 104b may correspond to a drop port and an add port of the photonic integrated circuit. Particular wavelengths or frequencies of optical signals in the optical modulator structure 102 may be coupled to the optical waveguide structure 104b and removed through the drop port for optical signal filtering of those wavelengths or frequencies. Conversely, the add port may be used to add optical signals of particular wavelengths or frequencies of optical signals to the optical modulator structure 102 by coupling those optical signals from the optical waveguide structure 104b to the optical modulator structure 102. In some implementations, the optical waveguide structure 104b is omitted from the semiconductor photonics device 100, and only the optical waveguide structure 104a is included in the semiconductor photonics device 100.

As further shown in FIG. 1A, the semiconductor photonics device 100 includes a modulator heater structure 106. The modulator heater structure 106 may be included above (e.g., vertically adjacent to) the optical modulator structure 102, below (e.g., vertically adjacent to) the optical modulator structure 102, and/or laterally adjacent (e.g., “in-line” or horizontally adjacent) to the optical modulator structure 102. As described above, the resonant wavelengths of the optical modulator structure 102 may be sensitive to variations in operating temperature. Thus, the modulator heater structure 106 may be configured to stabilize the operating temperature of the optical modulator structure 102 during operation of the optical modulator structure 102. In particular, the modulator heater structure 106 may heat (e.g., may increase the temperature of) the optical modulator structure 102 to an operating temperature setpoint or to a temperature in an operating temperature range, thereby stabilizing the operating performance of the optical modulator structure 102. Additionally and/or alternatively, the operating temperature setpoint may be selected to achieve a particular refractive index in the optical modulator structure 102 to achieve modulation (e.g., through the thermos-optic effect) of specific frequencies of optical signals that propagate through the optical modulator structure 102.

The modulator heater structure 106 may include one or more distribution pads 108a and/or 108b (other quantities of distribution pads are within the scope of the present disclosure) that may be electrically coupled and/or physically coupled with one or more backend metallization (e.g., back end of line (BEOL) metallization layers) in the semiconductor photonics device 100. The backend metallization layer(s) may be configured to provide an electrical current to the modulator heater structure 106. The distribution pads 108a and/or 108b may include a plurality of interconnected conductive structures (e.g., trenches, metallization layers, conductive traces) that are arranged to achieve a low electrical resistance in the distribution pads 108a and/or 108b to minimize current dissipation in the distribution pads 108a and/or 108b. The distribution pads 108a and/or 108b may include one or more electrically conductive materials such as tungsten (W), titanium (Ti), copper (Cu), ruthenium (Ru), cobalt (Co), and/or another electrically conductive material with low electrical resistance.

The distribution pads 108a and/or 108b are electrically coupled and/or physical coupled to a heater element 110 of the modulator heater structure 106. The heater element 110 may be included over (e.g., vertically adjacent to) the optical modulator structure 102, under (e.g., vertically adjacent to) the optical modulator structure 102, and/or laterally adjacent (e.g., “in-line” or horizontally adjacent) to the optical modulator structure 102. In some implementations, the heater element 110 laterally surrounds the optical modulator structure 102.

The heater element 110 may be configured to generate heat and radiate the heat toward the optical modulator structure 102. An electrical current may be provided to the heater element 110 through the distribution pads 108a and/or 108b, and the heater element 110 may dissipate the electrical current in the form of heat. The heater element 110 may include tungsten (W), titanium (Ti), copper (Cu), ruthenium (Ru), cobalt (Co), tantalum nitride (TaN), and/or another electrically conductive material, and/or another electrically conductive material that is capable of radiating heat toward the optical modulator structure 102. Additionally and/or alternatively, the heater element 110 may include one or more materials that have a higher electrical resistance than metal materials to achieve greater electrical current dissipation in the heater element 110 for greater heating efficiency. As an example, the heater element 110 may include a semiconductor material such as silicon (Si) and/or doped silicon.

In some implementations, the heater element 110 may be configured to maintain a consistent temperature of optical modulator structure 102 so that a particular refractive index may be achieved for the optical modulator structure 102. For example, the heater element 110 may be configured to maintain a consistent temperature of optical modulator structure 102 so that the refractive index for the optical modulator structure 102 is maintained in a range of approximately 2.75 to approximately 2.90. However, other ranges for the refractive index for the optical modulator structure 102 are within the scope of the present disclosure. The ambient temperature range for the optical modulator structure 102 may be approximately 25 degrees Celsius to approximately 105 degrees Celsius. However, other ranges for the ambient temperature range for the optical modulator structure 102 are within the scope of the present disclosure. The operating temperature range for the optical modulator structure 102 may be from 0 degrees Celsius to approximately 300 degrees Celsius. However, other ranges for the operating temperature range for the optical modulator structure 102 are within the scope of the present disclosure.

As shown in FIG. 1A, the heater element 110 may have an overall top view shape that substantially conforms to the top view shape of the optical modulator structure 102. For example, the optical modulator structure 102 may have an approximately ring to view shape, and the heater element 110 may have an overall circular top view shape that conforms to the approximately ring to view shape of the optical modulator structure 102. Alternatively, the heater element 110 may have an overall top view shape that is different than the top view shape of the optical modulator structure 102. Examples of such arrangements are illustrated in one or more of FIGS. 6A-6G.

As further shown in FIG. 1A, the heater element 110 includes a plurality of segments 112a-112c as opposed to being a solid ring shape. Two or more of the segments 112a-112c may be physically separated by a gap 114. For example, the segments 112a and 112c may be spaced apart by the gap 114, and the segments 112b and 112c may be spaced apart by the gap 114. Moreover, two or more of the segments 112a-112c may be electrically coupled and/or physically coupled by connector segments 116a and 116b such that the segments 112a-112c and the connector segments 116a and 116b may be concatenated to form a continuous serpentine arrangement. For example, the segment 112a may be electrically coupled and/or physically coupled to the distribution pad 108a at a first end (e.g., a proximal end) of the segment 112a, and the segment 112a may be electrically coupled and/or physically coupled to the connector segment 116a at a second end (e.g., a distal end) of the segment 112a opposing the first end. The segment 112c may be electrically coupled and/or physically coupled to the connector segment 116a at a first end of the segment 112c, and the segment 112c may be electrically coupled and/or physically coupled to the connector segment 116b at a second end of the segment 112c opposing the first end. The segment 112b may be electrically coupled and/or physically coupled to the distribution pad 108b at a first end (e.g., a proximal end) of the segment 112b, and the segment 112b may be electrically coupled and/or physically coupled to the connector segment 116b at a second end (e.g., a distal end) of the segment 112b opposing the first end. In this way, the segments 112a-112c and the connector segments 116a and 116b form a continuous current flow path between the distribution pads 108a and 108b through the heater element 110. The quantity and arrangements of segments 112a-112c and connector segments 116a and 116b illustrated in FIG. 1A is an example, and other quantities and arrangements of segments 112a-112c and connector segments 116a and 116b are within the scope of the present disclosure.

The electrical resistance through the heater element 110 can be represented as:

$${R}_{heater} = ρ \frac{L}{( W * t )}$$

where Rₕₑₐₜₑᵣ corresponds to the electrical resistance of the heater element 110, p corresponds to the resistivity of the material of the heater element 110, L corresponds to the length of the current flow path through the heater element 110, W is the cross-sectional width of the current flow path of the heater element 110, and t is the thickness of the heater element 110. The serpentine arrangement (e.g., the doubling back of two or more of the segments 112a-112c along each other) increases the overall length of the current path (L) through the heater element 110 and decreases the cross-sectional width (W) of the current path (e.g., as compared to a solid ring-shape heater element), which increases the electrical resistance in the heater element 110 (Rₕₑₐₜₑᵣ), thereby increasing the thermal efficiency of the heater element 110.

As shown in FIG. 1A, the segments 112a-112c may be curved segments such that the overall top view shape of the heater element 110 conforms to the top view shape of the modulator structure 102. Additionally and/or alternatively, the heater element 110 may include one or more segments that are straight-lined segments. The straight-lined segments may be arranged in various configurations, such as in an L-shape, in an N-shape, in a trident shape (or E-shape or W-shape), and/or in another arrangement.

Two or more of the segments 112a-112c may form a “doubled back” current path on each other in that two or more of the segments 112a-112c may be coupled at first ends of the two or more of the segments 112a-112c at a connector segment 116a or 116b, and may extend alongside each other and may have a similar curvature. For example, the segment 112a and a portion of the segment 112c may extend alongside each other and may be electrically coupled together by the connector segment 116a. Thus, the current path through the heater element 110 may extend from the distribution pad 108a, through the segment 112a, through the connector segment 116a, and through the portion of the segment 112c such that the current path doubles back along the segment 112a through the portion of the segment 112c. As another example, the segment 112b and another portion of the segment 112c may extend alongside each other and may be electrically coupled together by the connector segment 116b. Thus, the current path through the heater element 110 may extend from the distribution pad 108a, through the segment 112b, through the connector segment 116b, and through the portion of the segment 112c such that the current path doubles back along the segment 112b through the portion of the segment 112c. Thus, the heater element 110 may include a plurality of sets of approximately curved segments having similar curvature, including a set that includes the segment 112a and a portion of the segment 112c, and another set that includes the segment 112b and another portion of the segment 112c.

The ends of the segment 112c may be located at a distal side (e.g., a side further away from the distribution pads 108a and 108b) of the heater element 110. The segment 112c may have an approximate C-shape (or backwards C-shape) top view shape to enable the ends of the segment 112c to be coupled to the connector segments 116a and 116b at the distal side of the heater element 110. The connector segments 116a and 116b may be spaced apart from each other by a gap 118 at the distal side, and the distribution pads 108a and 108b may be spaced apart from each other at a proximal side of the heater element 110. In other implementations the gap 118 and the associated connector segments 116a and/or 116b may be located at other locations along the heater element 110.

FIG. 1B illustrates a detailed top view of the serpentine arrangement of the heater element 110. As shown in FIG. 1B, the segment 112a and a section 122 of the segment 112c may be located at a first side of the heater element 110 and on a first side of the gaps 118 and 120, and the segment 112b and a section 124 of the segment 112c may be located at a second side of the heater element 110 and on a second side of the gaps 118 and 120. The segments 112a and 112b may be mirrored in the x-direction relative to each other. The set of the segment 112a and the section 122 of the segment 112c may be approximately symmetrical to the set of the segment 112b and the section 124 of the segment 112c along a line through the gaps 118 and 120 in the y-direction. However, asymmetric arrangements for the segments of the heater element 110 are within the scope of the present disclosure.

As further shown in FIG. 1B, the heater element 110 may have one or more example dimensions. One example dimension D1 includes a radius of the heater element 110 between a center point of the heater element 110 and a midpoint 126 along the overall cross-sectional width of the heater element 110. In some implementations, the radius of the heater element 110 is included in a range of approximately 3 microns to approximately 16 microns. In some implementations, the radius of the heater element 110 is selected so that the heater element 110 at least partially overlaps with the optical modulator structure 102. In some implementations, the radius of the heater element 110 is selected so that the heater element 110 can be placed laterally around the optical modulator structure 102. Moreover, other values and ranges for the radius of the heater element 110 are within the scope of the present disclosure.

Another example dimension D2 includes a cross-sectional width of the outer segments, such as the segment 112a and/or the segment 112b. In some implementations, the cross-sectional width of the outer segments may be included in a range of approximately 0.5 microns to approximately 1 microns to provide sufficient thermal heating while enabling gap(s) 114 to be provided between segments for a particular radius (dimension D1). However, other values and ranges for the cross-sectional width of the outer segments are within the scope of the present disclosure.

Another example dimension D3 includes a cross-sectional width of the inner segment (e.g., the C-shaped segment 112c). In some implementations, the cross-sectional width of the inner segment may be included in a range of approximately 0.5 microns to approximately 1 microns to provide sufficient thermal heating while enabling gap(s) 114 to be provided between segments for a particular radius (dimension D1). However, other values and ranges for the cross-sectional width of the inner segment are within the scope of the present disclosure.

In some implementations, the cross-sectional width of the outer segments (e.g., the segments 112a and/or 112b) and the cross-sectional width of the inner segment (e.g., the segment 112c) are approximately a same cross-sectional width. In some implementations, the cross-sectional width of the outer segments (e.g., the segments 112a and/or 112b) and the cross-sectional width of the inner segment (e.g., the segment 112c) are different cross-sectional widths.

Another example dimension D4 includes a width of the gap 114 between two or more segments, such as between the segments 112a and 112c, and/or between the segments 112b and 112c. In some implementations, the width of the gap 114 may be included in a range of approximately 0.25 microns to approximately 0.75 microns to reduce the likelihood of electrical shorting between adjacent segments while enabling a plurality of segments to be included for a particular radius (dimension D1). However, other values and ranges for the width of the gap 114 are within the scope of the present disclosure.

Another example dimension D5 includes a width of the gap 118 between two or more connector segments, such as between the connector segments 116a and 116b. In some implementations, the width of the gap 114 may be included in a range of approximately 0.25 microns to approximately 0.75 microns to reduce the likelihood of electrical shorting between adjacent connector segments while enabling a plurality of segments to be included for a particular radius (dimension D1). However, other values and ranges for the width of the gap 118 are within the scope of the present disclosure. In some implementations, the width of the gap 118 and the width of the gap 114 are approximately equal. In some implementations, the width of the gap 118 and the width of the gap 114 are different widths.

Another example dimension D6 includes a width of the gap 120 between the ends of two or more segments, such as between the ends of the segments 112a and 112b. In some implementations, the width of the gap 120 may be included in a range of approximately 0.25 microns to approximately 0.75 microns to reduce the likelihood of electrical shorting between the ends of segments while enabling a plurality of segments to be included for a particular radius (dimension D1). However, other values and ranges for the width of the gap 120 are within the scope of the present disclosure. In some implementations, the width of the gap 120 and the width of the gap 114 are approximately equal. In some implementations, the width of the gap 120 and the width of the gap 114 are different widths.

Another example dimension D7 includes a radius offset between the radius of the heater element 110 (dimension D1) and a midpoint radius of the optical modulator structure 102. In the example in FIGS. 1A-1C, the midpoint radius of the optical modulator structure 102 is greater than the radius of the heater element 110. In other implementations, the midpoint radius of the optical modulator structure 102 is less than the radius of the heater element 110, or the midpoint radius of the optical modulator structure 102 and the radius of the heater element 110 are approximately equal. The radius offset between the radius of the heater element 110 and the midpoint radius of the optical modulator structure 102 may be included in a range of approximately −0.75 microns to approximately +0.75 microns. However, other values and ranges for the radius offset are within the scope of the present disclosure.

For the same midpoint radius of the optical modulator structure 102, and for the same segment configuration for the heater element 110, decreasing the radius of the heater element 110 may decrease the power consumption of the heater element 110, may increase the operating temperature of the heater element 110, and/or may enable lower voltages to be used for the heater element 110 to achieve a particular operating temperature. On the other hand, increasing the radius of the heater element may increase the power consumption of the heater element, may decrease the operating temperature of the heater element, and/or may enable higher voltages to be used for the heater element to achieve a particular operating temperature. However, increasing the radius of the heater element 110 may provide greater area for a greater quantity of segments, and a greater quantity of segments may enable greater operating temperatures to be achieved for the heater element 110 and/or may decrease the power consumption of the heater element in that the length of the current path is increased and/or the width of the cross-sectional current path is decreased.

FIG. 1C illustrates a cross-sectional view of the semiconductor photonics device 100 along the line A-A in FIG. 1A. As shown in FIG. 1C, the semiconductor photonics device 100 may include a substrate layer 128 and a dielectric region 130 above the substrate layer 128. The substrate layer 128 may include a semiconductor substrate, such as a silicon (Si) substrate, a silicon germanium (SiGe) substrate, a germanium (Ge) substrate, and/or another type of semiconductor substrate. The dielectric region 130 may include one or more dielectric layers that include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

The optical modulator structure 102 and the optical waveguide structures 104a and/or 104b may be included in the dielectric region 130. In the example in FIG. 1C, the modulator heater structure 106, including the segments 112a-112c of the heater element 110, may be included above the optical modulator structure 102 in the z-direction in the semiconductor photonics device 100.

In some implementations, one or more contact structures 132 may be electrically coupled and/or physically coupled to the optical modulator structure 102. The contact structures 132 may be electrically coupled and/or physically coupled to metallization layers 134 in the dielectric region 130. The metallization layers 134 may enable electrical inputs to be provided to the optical modulator structure 102 through the contact structures 132.

The distribution pads 108a and 108b of the modulator heater structure 106 may be electrically coupled and/or physically coupled to contact structures 136 above the modulator heater structure 106. The contact structures 136 may be electrically coupled and/or physically coupled to a top metallization layer 138 above the contact structures 136 in the dielectric region 130. The top metallization layer 138 may enable electrical inputs to be provided to the modulator heater structure 106 through the contact structures 136.

The contact structures 132 and 136 may include contact plugs, vias, columns, and/or other types of contact structures. The contact structures 132 and 136 may each include tungsten (W), cobalt (Co), ruthenium (Ru), titanium (Ti), aluminum (Al), copper (Cu) or gold (Au), among other examples of conductive materials.

The metallization layers 134 and the top metallization layer 138 may each include tungsten (W), cobalt (Co), ruthenium (Ru), titanium (Ti), aluminum (Al), copper (Cu) or gold (Au), among other examples of conductive materials. The metallization layers 134 and the top metallization layer 138 may each include vias, trenches, contact plugs, and/or another type of metallization layers.

As indicated above, FIGS. 1A-1C are provided as an example. Other examples may differ from what is described with regard to FIGS. 1A-1C.

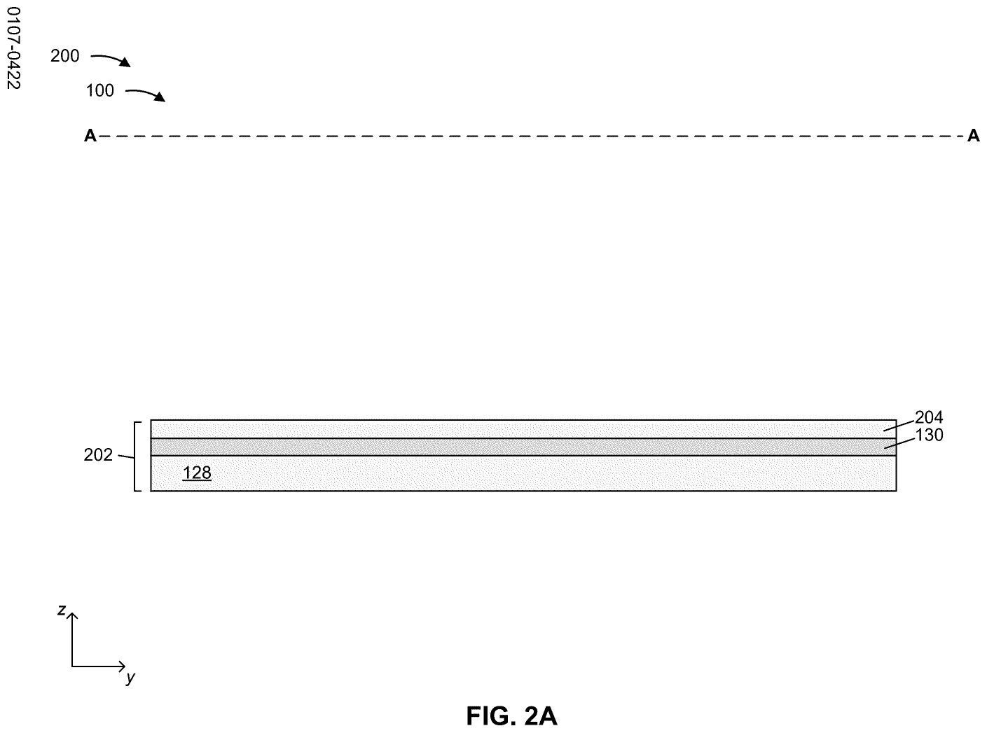

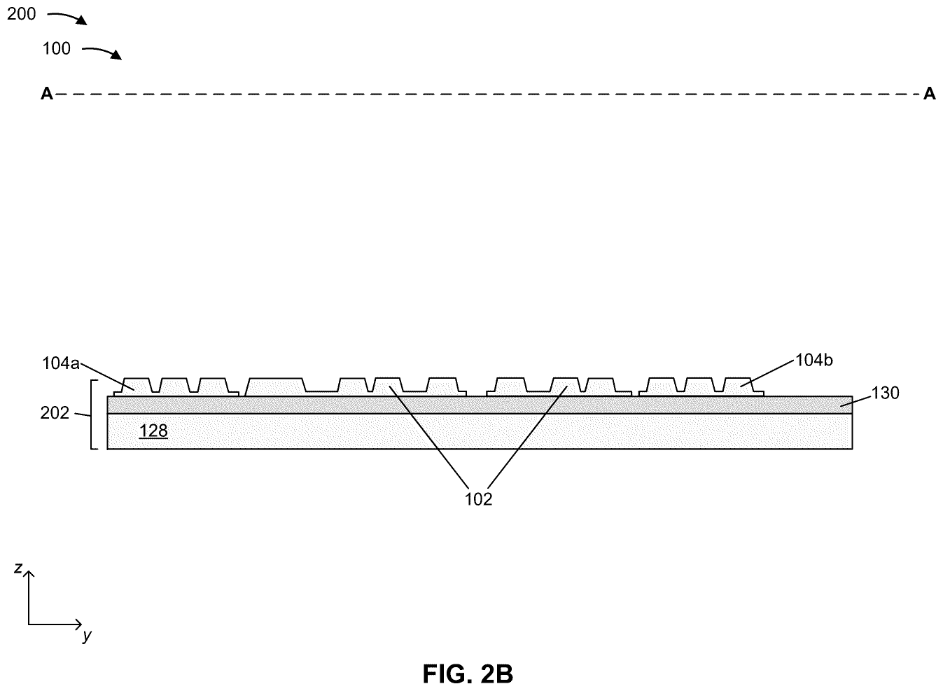

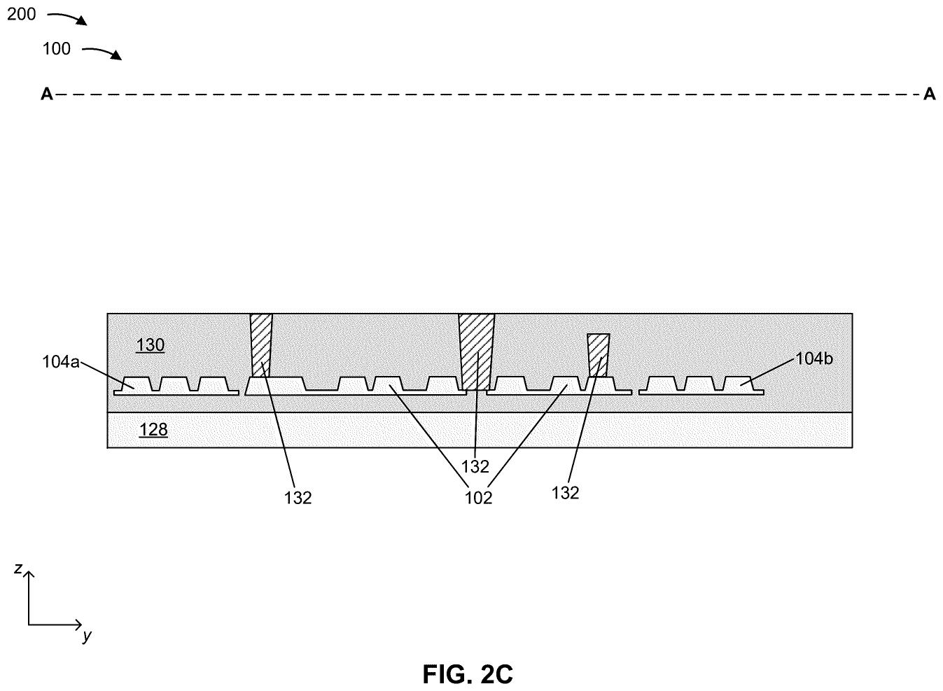

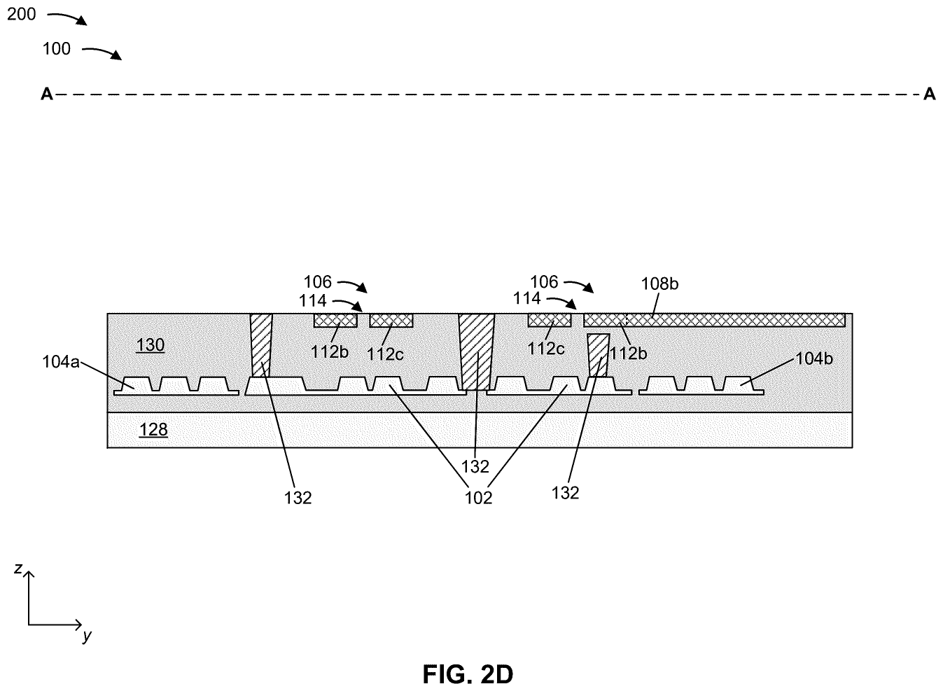

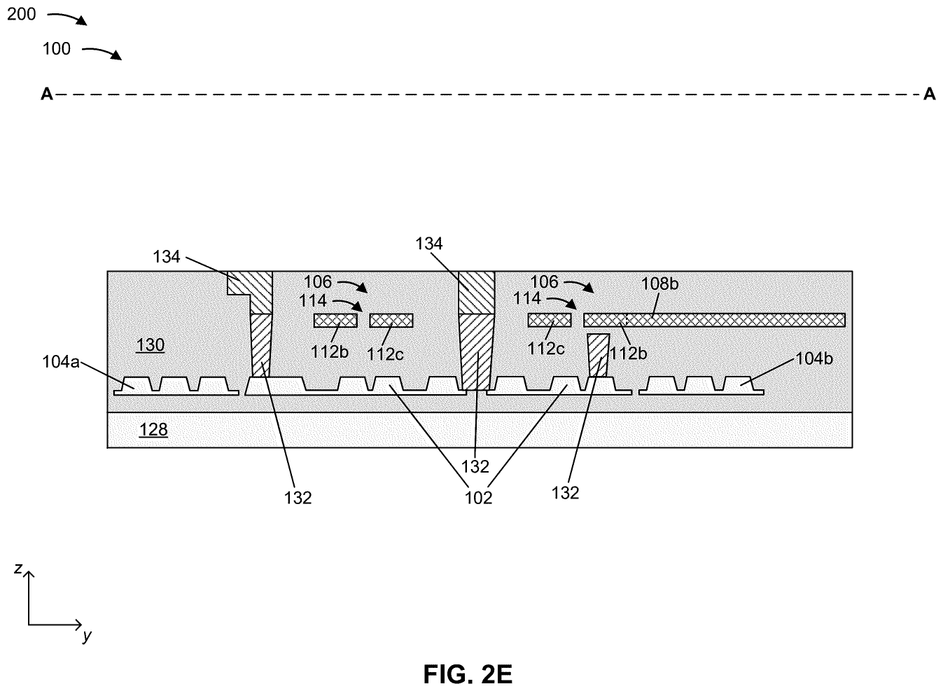

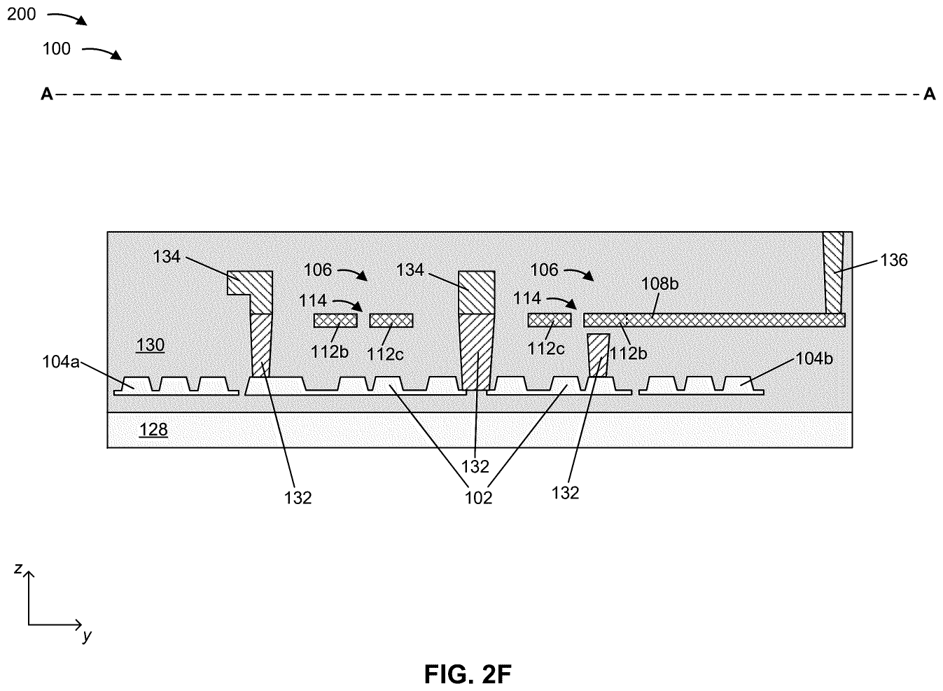

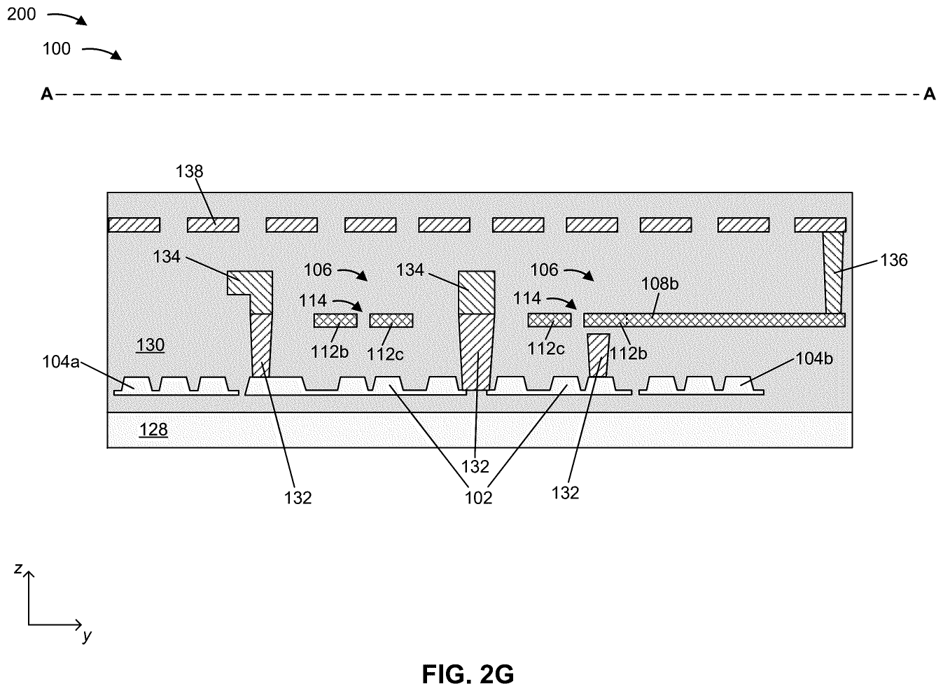

FIGS. 2A-2G are diagrams of an example implementation 200 of forming a semiconductor photonics device 100 described herein. The example implementation 200 may include an example of forming a photonic integrated circuit in the semiconductor photonics device 100, where the photonic integrated circuit includes an optical modulator structure 102 and a modulator heater structure 106. In some implementations, one or more of the operations described in connection with FIGS. 2A-2G may be performed using one or more semiconductor processing tools, such as a deposition tool, an exposure tool, a developer tool, an etch tool, a planarization tool, and/or another semiconductor processing tool.

As shown in FIG. 2A, the semiconductor photonics device 100 may be formed on a substrate 202. The substrate 202 may include a silicon on insulator (SOI) substrate that includes the substrate layer 128, a portion of the dielectric region 130 (e.g., a buried oxide (BOX) layer) on the substrate layer 128, and a semiconductor layer 204 on the portion of the dielectric region 130. The substrate 202 may be provided as a pre-manufactured wafer.

Alternatively, the substrate layer 128 may be provided as a semiconductor wafer (e.g., a silicon (Si) wafer), and the portion of the dielectric region 130 and the semiconductor layer 204 may be formed on the substrate layer 128. For example, a deposition tool may be used to deposit the portion of the dielectric region 130 using a physical vapor deposition (PVD) technique, an atomic layer deposition (ALD) technique, a chemical vapor deposition (CVD) technique, an oxidation technique, and/or another suitable deposition technique. In some implementations, a planarization tool may be used to perform a planarization operation (e.g., a chemical mechanical planarization (CMP) operation) to planarize the portion of the dielectric region 130 after the portion of the dielectric region 130 is deposited. A deposition tool may be used to deposit the semiconductor layer 204 an epitaxy technique and/or another suitable deposition technique.

As shown in FIG. 2B, the semiconductor layer 204 may be etched to form the optical waveguide structures 104a and/or 104b, and the optical modulator structure 102. In some implementations, a pattern in a photoresist layer is used to etch the semiconductor layer 204 to form the optical waveguide structures 104a and/or 104b, and the optical modulator structure 102. In these implementations, a deposition tool may be used to form the photoresist layer on the semiconductor layer 204 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the semiconductor layer 204 based on the pattern to form the optical waveguide structures 104a and/or 104b, and the optical modulator structure 102. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the semiconductor layer 204 based on a pattern.

As shown in FIG. 2C, additional material of the dielectric region 130 may be formed over the optical waveguide structures 104a and/or 104b, and the optical modulator structure 102. A deposition tool may be used to deposit the additional material of the dielectric region 130 using a PVD technique, an ALD technique, a CVD technique, an oxidation technique, and/or another suitable deposition technique. In some implementations, a planarization tool may be used to perform a planarization operation (e.g., a CMP operation) to planarize the dielectric region 130 after the additional material of the dielectric region 130 is deposited.

In some implementations, a shallow trench isolation (STI) portion of the dielectric region 130 is formed, and metal silicide layers are formed on terminal regions of the optical modulator structure 102 by salicidation. Subsequently, additional material of the dielectric region 130 is then formed. The metal silicide layers may include titanium silicide (TiSi), ruthenium silicide (RuSi), and/or another suitable metal silicide material. The metal silicide layers may be included to reduce the contact resistance between the optical modulator structure 102 and contact structures 132 that are formed on the optical modulator structure 102.

As further shown in FIG. 2C, the contact structures 132 may be formed on the optical modulator structure 102. In some implementations, the contact structures 132 are formed on the metal silicide layers on the optical modulator structure 102. The contact structures 132 may be formed in recesses in the dielectric region 130.

In some implementations, a pattern in a photoresist layer is used to etch the dielectric region 130 to form the recesses. In these implementations, a deposition tool may be used to form the photoresist layer on the dielectric region 130 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 130 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric region 130 based on a pattern.

A deposition tool may be used to deposit the contact structures 132 using a CVD technique, a PVD technique, an ALD technique, an electroplating technique, and/or another suitable deposition technique. The contact structures 132 may be deposited in one or more deposition operations. In some implementations, a liner is fired deposited in the recesses, and the contact structures 132 are formed on the liner. The liner may include a barrier liner, an adhesion liner, and/or another type of liner, and may include tantalum nitride (TaN), titanium nitride (TiN), and/or another suitable liner material. In some implementations, a seed layer is first deposited, and the contact structures 132 are deposited on the seed layer. In some implementations, a planarization tool is used to perform a planarization operation (e.g., a CMP operation) to planarize the contact structures 132 after the contact structures 132 are deposited.

As shown in FIG. 2D, the modulator heater structure 106 may be formed in the dielectric region 130. In the example illustrated in FIG. 2B, the modulator heater structure 106 is formed above and/or over the optical modulator structure 102. Additionally and/or alternatively, the modulator heater structure 106 may be formed first, and then the optical modulator structure 102 is formed above the modulator heater structure 106 such that the modulator heater structure 106 is below and/or under the optical modulator structure 102. Additionally and/or alternatively, the modulator heater structure 106 is formed “in-line” with the optical modulator structure 102 such that the modulator heater structure 106 is laterally adjacent to (and in some implementations, laterally surrounds) the optical modulator structure 102.

The heater element 110 of the modulator heater structure 106 may be formed to include a plurality of segments (e.g., segments 102a-102c) that are concatenated by connector segments (116a, 116b) of the heater element 110. Moreover, the heater element 110 of the modulator heater structure 106 may be formed such that one or more of the segments are electrically coupled and/or physically coupled to one or more distribution pads (e.g., distribution pads 108a, 108b) of the modulator heater structure 106.

The modulator heater structure 106 may be formed in recesses in the dielectric region 130. In some implementations, a pattern in a photoresist layer is used to etch the dielectric region to form the recesses. In these implementations, a deposition tool may be used to form the photoresist layer on the dielectric region 130 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 130 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric region 130 based on a pattern.

A deposition tool may be used to deposit the modulator heater structure 106 using a CVD technique, a PVD technique, an ALD technique, an electroplating technique, and/or another suitable deposition technique. The modulator heater structure 106 may be deposited in one or more deposition operations. In some implementations, a seed layer is first deposited, and the modulator heater structure 106 is deposited on the seed layer. In some implementations, a planarization tool is used to perform a planarization operation (e.g., a CMP operation) to planarize the modulator heater structure 106 after the modulator heater structure 106 is deposited.

As shown in FIG. 2E, additional material of the dielectric region 130 may be formed over the contact structures 132 and the modulator heater structure 106. A deposition tool may be used to deposit the additional material of the dielectric region 130 using a PVD technique, an ALD technique, a CVD technique, an oxidation technique, and/or another suitable deposition technique. In some implementations, a planarization tool may be used to perform a planarization operation (e.g., a CMP operation) to planarize the dielectric region 130 after the additional material of the dielectric region 130 is deposited.

As further shown in FIG. 2E, the metallization layer(s) 134 may be formed in the dielectric region 130. In some implementations, one or more metallization layers 134 are formed on the contact structures 132. In some implementations, one or more metallization layers 134 are formed on other structures in the dielectric region 130.

The metallization layer(s) 134 may be formed in recesses in the dielectric region 130. In some implementations, a pattern in a photoresist layer is used to etch the dielectric region 130 to form the recesses. In these implementations, a deposition tool may be used to form the photoresist layer on the dielectric region 130 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 130 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric region 130 based on a pattern.

A deposition tool may be used to deposit the metallization layer(s) 134 using a CVD technique, a PVD technique, an ALD technique, an electroplating technique, and/or another suitable deposition technique. The metallization layer(s) 134 may be deposited in one or more deposition operations. In some implementations, a liner is fired deposited in the recesses, and the metallization layer(s) 134 are formed on the liner. The liner may include a barrier liner, an adhesion liner, and/or another type of liner, and may include tantalum nitride (TaN), titanium nitride (TiN), and/or another suitable liner material. In some implementations, a seed layer is first deposited, and the metallization layer(s) 134 are deposited on the seed layer. In some implementations, a planarization tool is used to perform a planarization operation (e.g., a CMP operation) to planarize the metallization layer(s) 134 after the metallization layer(s) 134 are deposited.

As shown in FIG. 2F, additional material of the dielectric region 130 may be formed over the metallization layer(s) 134. A deposition tool may be used to deposit the additional material of the dielectric region 130 using a PVD technique, an ALD technique, a CVD technique, an oxidation technique, and/or another suitable deposition technique. In some implementations, a planarization tool may be used to perform a planarization operation (e.g., a CMP operation) to planarize the dielectric region 130 after the additional material of the dielectric region 130 is deposited.

As further shown in FIG. 2F, the contact structure(s) 136 may be formed in the dielectric region 130. The contact structure(s) 136 formed on the distribution pads 108a and/or 108b of the modulator heater structure 106 such that the contact structure(s) 136 are electrically coupled and/or physically coupled to the modulator heater structure 106.

The contact structure(s) 136 may be formed in recesses in the dielectric region 130. In some implementations, a pattern in a photoresist layer is used to etch the dielectric region 130 to form the recesses. In these implementations, a deposition tool may be used to form the photoresist layer on the dielectric region 130 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 130 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric region 130 based on a pattern.

A deposition tool may be used to deposit the contact structure(s) 136 using a CVD technique, a PVD technique, an ALD technique, an electroplating technique, and/or another suitable deposition technique. The contact structure(s) 136 may be deposited in one or more deposition operations. In some implementations, a liner is fired deposited in the recesses, and the contact structure(s) 136 are formed on the liner. The liner may include a barrier liner, an adhesion liner, and/or another type of liner, and may include tantalum nitride (TaN), titanium nitride (TiN), and/or another suitable liner material. In some implementations, a seed layer is first deposited, and the contact structure(s) 136 are deposited on the seed layer. In some implementations, a planarization tool is used to perform a planarization operation (e.g., a CMP operation) to planarize the contact structure(s) 136 after the contact structure(s) 136 are deposited.

As shown in FIG. 2G, additional material of the dielectric region 130 may be formed over the contact structure(s) 136. A deposition tool may be used to deposit the additional material of the dielectric region 130 using a PVD technique, an ALD technique, a CVD technique, an oxidation technique, and/or another suitable deposition technique. In some implementations, a planarization tool may be used to perform a planarization operation (e.g., a CMP operation) to planarize the dielectric region 130 after the additional material of the dielectric region 130 is deposited.

As further shown in FIG. 2G, the top metallization layer 138 may be formed in the dielectric region 130. In some implementations, a portion of the top metallization layer 138 is formed on the contact structure(s) 136. In some implementations, a portion of the top metallization layer 138 is formed on other structures in the dielectric region 130.

The top metallization layer 138 may be formed in recesses in the dielectric region 130. In some implementations, a pattern in a photoresist layer is used to etch the dielectric region 130 to form the recesses. In these implementations, a deposition tool may be used to form the photoresist layer on the dielectric region 130 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 130 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric region 130 based on a pattern.

A deposition tool may be used to deposit the top metallization layer 138 using a CVD technique, a PVD technique, an ALD technique, an electroplating technique, and/or another suitable deposition technique. The top metallization layer 138 may be deposited in one or more deposition operations. In some implementations, a liner is fired deposited in the recesses, and the top metallization layer 138 is formed on the liner. The liner may include a barrier liner, an adhesion liner, and/or another type of liner, and may include tantalum nitride (TaN), titanium nitride (TiN), and/or another suitable liner material. In some implementations, a seed layer is first deposited, and the top metallization layer 138 is deposited on the seed layer. In some implementations, a planarization tool is used to perform a planarization operation (e.g., a CMP operation) to planarize the top metallization layer 138 after the top metallization layer 138 is deposited.

As indicated above, FIGS. 2A-2G are provided as an example. Other examples may differ from what is described with regard to FIGS. 2A-2G.

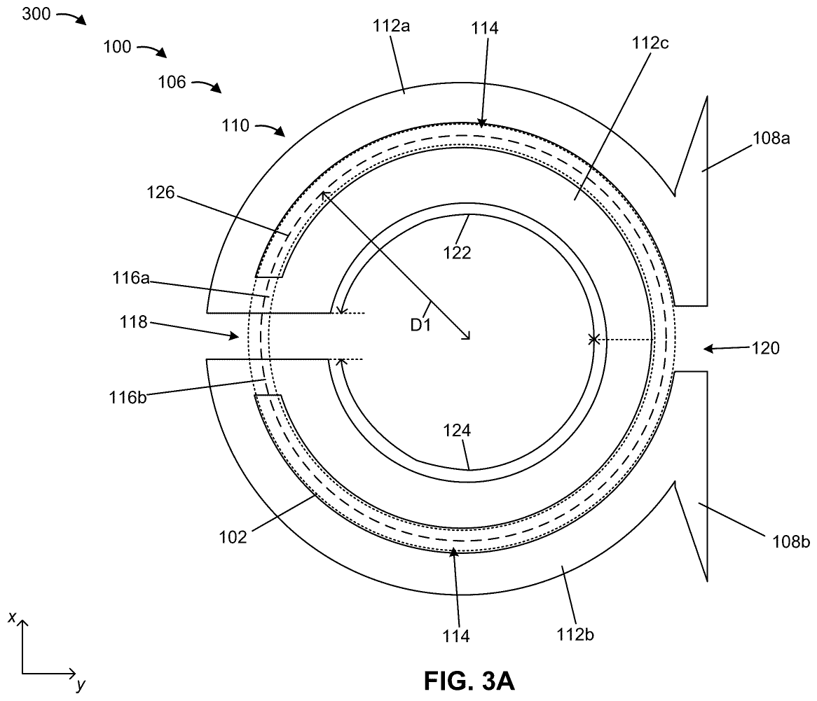

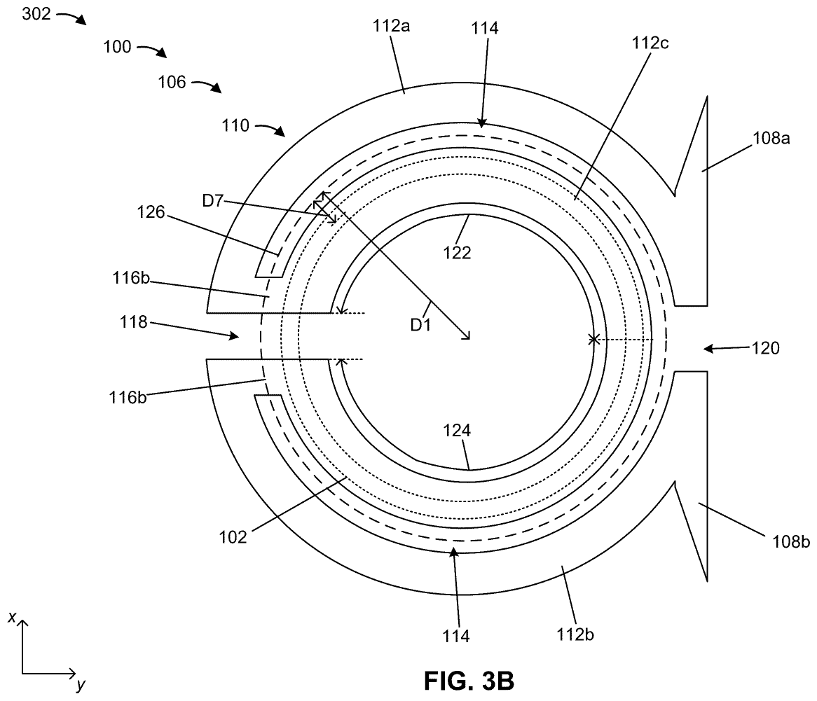

FIGS. 3A and 3B are diagrams of example implementations of a heater element 110 of a modulator heater structure 106 described herein. The example implementations illustrated in FIGS. 3A and 3B are examples of different radiuses for the heater element 110.

In an example implementation 300 illustrated in FIG. 3A, the radius of the heater element 110 (dimension D1) and the radius of the optical modulator structure 102 are approximately equal such that the radius offset (dimension D7) is approximately 0 microns. In the example implementation 300, the gap 114 between the segments 102a and 102c, and between the segments 102b and 102c, may be located directly above the optical modulator structure 102.

In an example implementation 302 illustrated in FIG. 3B, the radius of the heater element 110 (dimension D1) is greater than the radius of the optical modulator structure 102. This results in a non-zero radius offset (dimension D7). In the example implementation 302, the segments 102a may be located directly above the optical modulator structure 102.

As described above, decreasing the radius (dimension D1) of the heater element 110 may decrease the power consumption of the heater element 110, may increase the operating temperature of the heater element 110, and/or may enable lower voltages to be used for the heater element 110 to achieve a particular operating temperature. Increasing the radius of the heater element 110 may provide greater area for a greater quantity of segments, and a greater quantity of segments may enable greater operating temperatures to be achieved for the heater element 110 and/or may decrease the power consumption of the heater element in that the length of the current path is increased and/or the width of the cross-sectional current path is decreased.

As indicated above, FIGS. 3A and 3B are provided as examples. Other examples may differ from what is described with regard to FIGS. 3A and 3B.

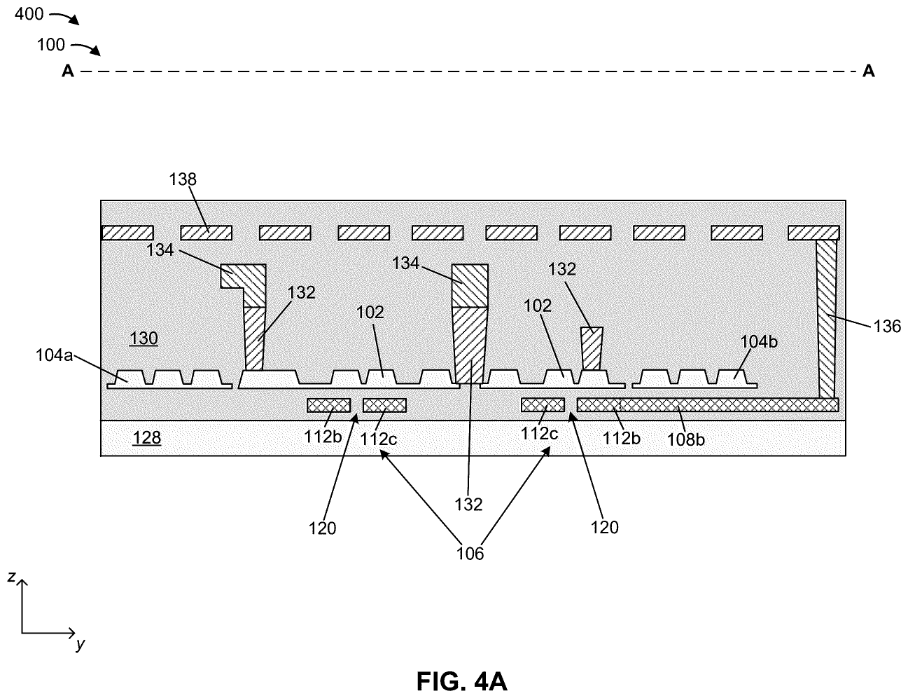

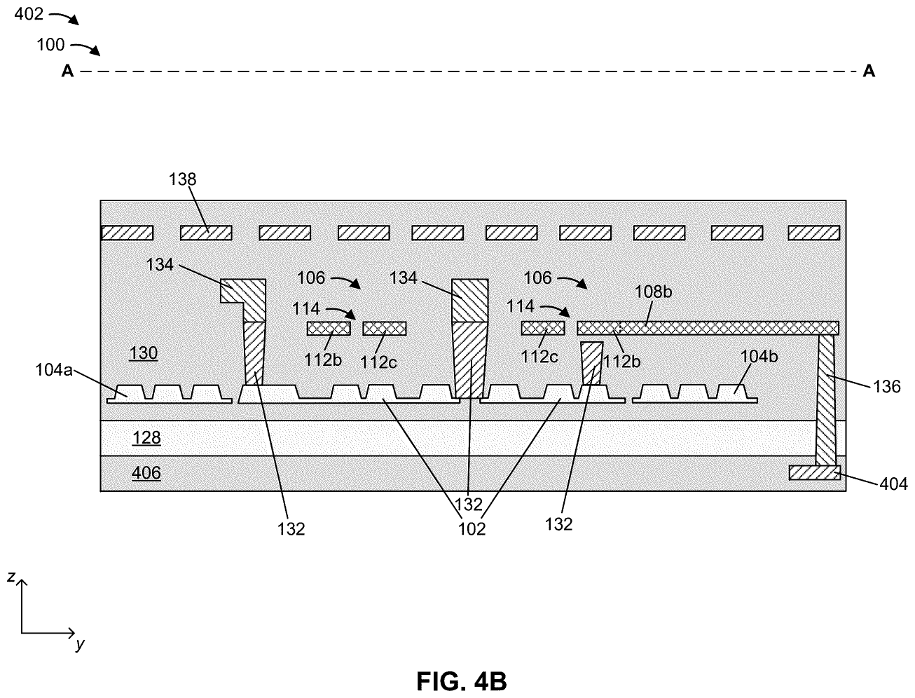

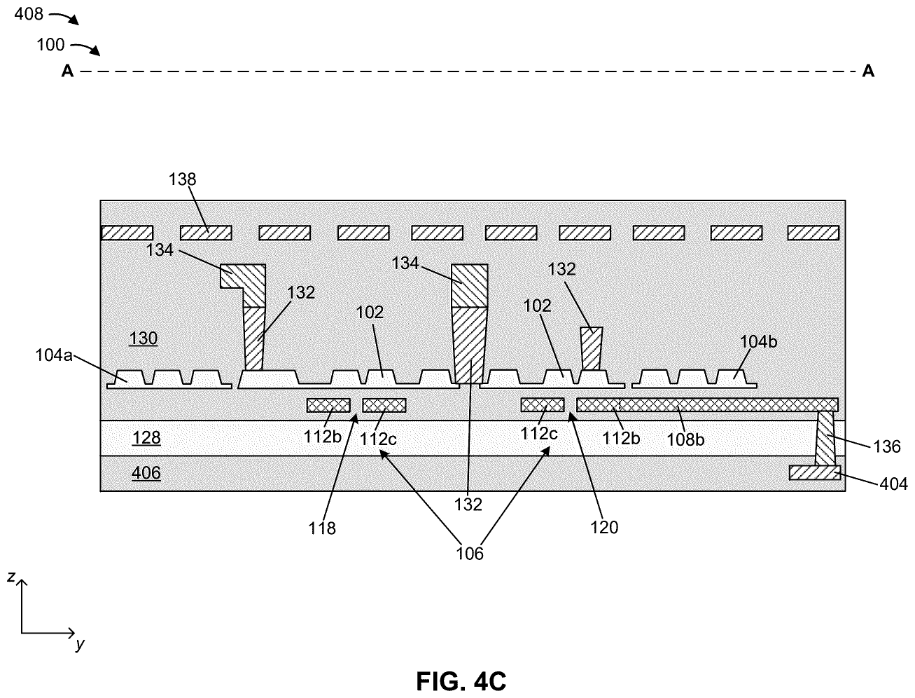

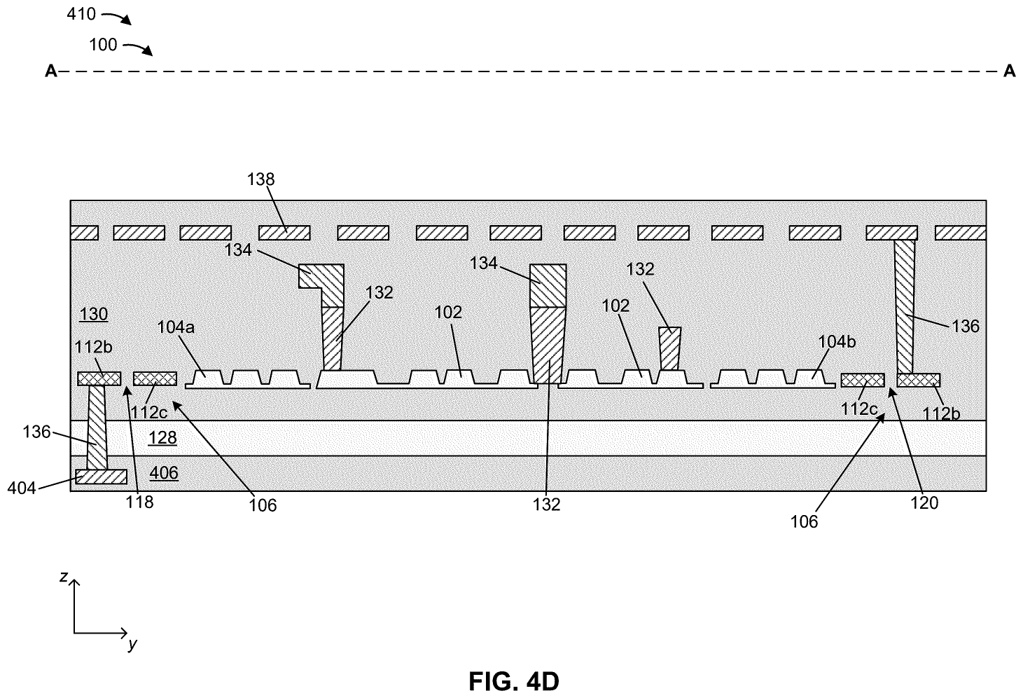

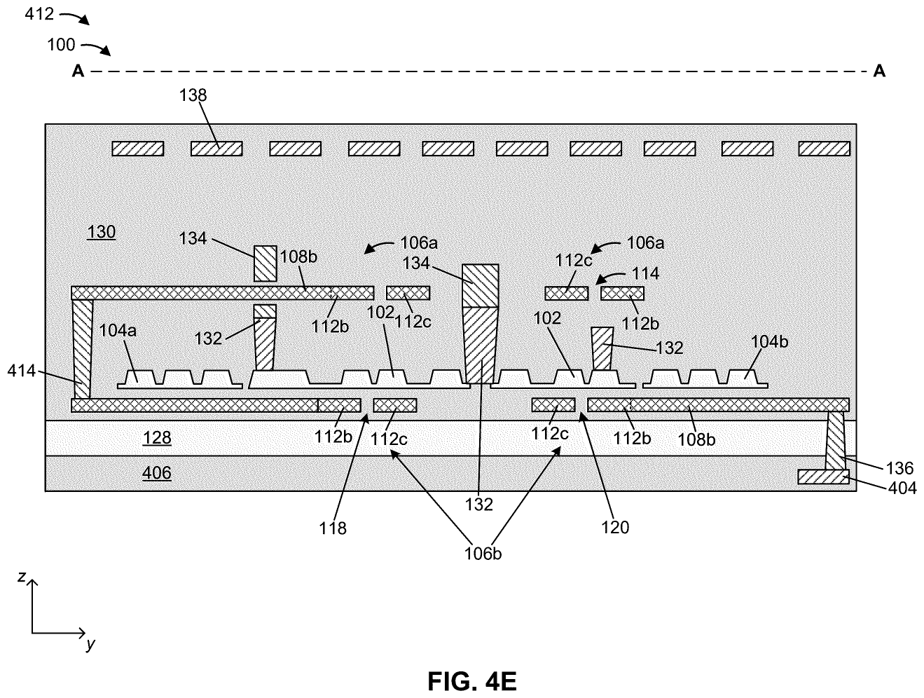

FIGS. 4A-4E are diagrams of example implementations of alternative placement of a modulator heater structure 106 described herein. In FIG. 1C, the modulator heater structure 106 is located above the optical modulator structure 102, and is electrically connected to the top metallization layer 138 through one or more contact structures 136.

In an example implementation 400 illustrated in FIG. 4A, the modulator heater structure 106 is located below and/or under the optical modulator structure 102, and is electrically connected to the top metallization layer 138 through one or more contact structures 136. Thus, in the example implementation 400, the modulator heater structure 106 may be referred to as a backside heater, and may be configured to radiate heat upward toward the optical modulator structure 102.

In an example implementation 402 illustrated in FIG. 4B, the modulator heater structure 106 is located above and/or over the optical modulator structure 102, similar to the example implementation in FIG. 1C. However, in the example implementation 402, the distribution pads 108a and/or 108b of the modulator heater structure 106 may be electrically connected to a backside metallization layer 404 through one or more contact structures 136. The backside metallization layer 404 may be located in a backside dielectric region 406 on a backside of the substrate layer 128. The backside metallization layer 404 in the backside dielectric region 406 may include additional interconnects for power delivery and/or signal propagation on the backside of the substrate layer 128.

In an example implementation 408 illustrated in FIG. 4C, the modulator heater structure 106 is located below and/or under the optical modulator structure 102, and is electrically connected to the backside metallization layer 404 in the backside dielectric region 406 through one or more contact structures 136. Thus, in the example implementation 408, the modulator heater structure 106 may be referred to as a backside heater, and may be configured to radiate heat upward toward the optical modulator structure 102.

In an example implementation 410 illustrated in FIG. 4D, the modulator heater structure 106 is located laterally adjacent to the optical modulator structure 102. The modulator heater structure 106 may laterally surround the optical modulator structure 102 may be radiate heat laterally toward the optical modulator structure 102. The modulator heater structure 106 may be electrically connected to the top metallization layer 138 through one or more contact structures 136 and/or may be electrically connected to the backside metallization layer 404 in the backside dielectric region 406 through one or more contact structures 136.

The example implementations illustrated in FIGS. 1C and 4A-4C may enable a smaller lateral footprint to be achieved for the optical modulator structure 102 and the associated modulator heater structure 106, whereas the example implementation 410 illustrated in FIG. 4D may enable a smaller vertical footprint to be achieved for the optical modulator structure 102 and the associated modulator heater structure 106.

In an example implementation 412 illustrated in FIG. 4E, the optical modulator structure 102 is located vertically between a plurality of modulator heater structures 106a and 106b. The modulator heater structure 106a may be located above and/or over the optical modulator structure 102, and the modulator heater structure 106b may be located below and/or under the optical modulator structure 102. The modulator heater structures 106a and 106b may be configured according to one or more of the example implementations described herein, where the modulator heater structures 106a and/or 106b include a plurality of segments. The modulator heater structures 106a and 106b may be electrically connected together by an interconnect structure 414 in the dielectric region 130, and may be electrically connected to the top metallization layer 138 through one or more contact structures 136 and/or may be electrically connected to the backside metallization layer 404 in the backside dielectric region 406 through one or more contact structures 136.

As indicated above, FIGS. 4A-4E are provided as examples. Other examples may differ from what is described with regard to FIGS. 4A-4E.

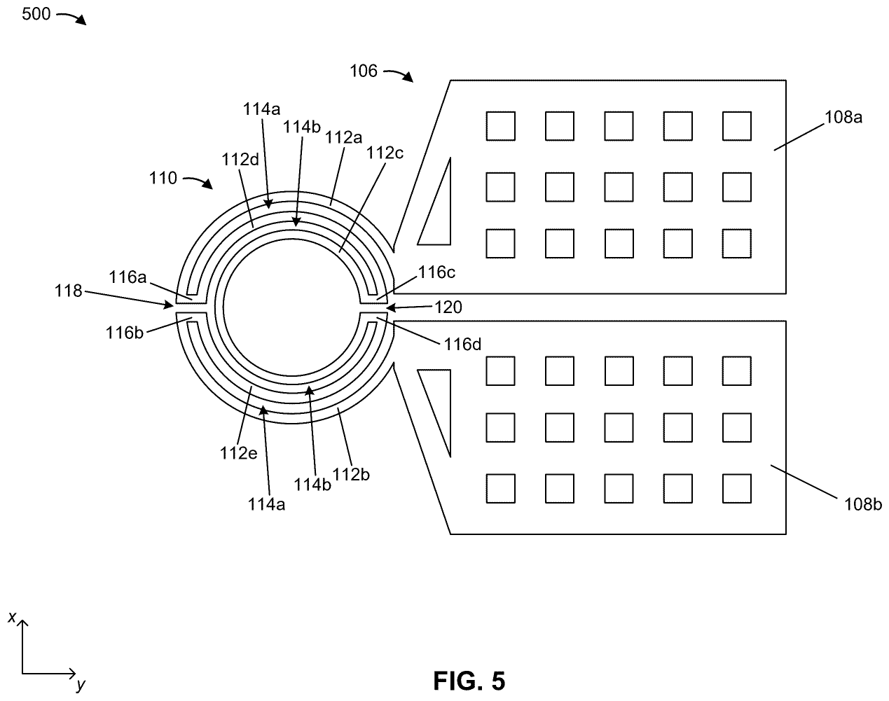

FIG. 5 is a diagram of an example implementation 500 of a modulator heater structure 106 described herein. As shown in FIG. 5, the example implementation 500 of the modulator heater structure 106 includes a similar top view configuration as the modulator heater structure 106 in FIGS. 1A-1C. However, in the example implementation 500, the modulator heater structure 106 includes additional segments 112d and 112e, a plurality of gaps 114a and 114b, and additional connector segments 116c and 116d, which further increase the length of the current flow path through the heater element 110 of the modulator heater structure 106. The increased length of the current flow path through the heater element 110 may further increase the electrical resistance in the heater element 110, thereby further increasing the thermal efficiency of the heater element 110.

As shown in FIG. 5, a first end of the segment 112a may be electrically coupled and/or physically coupled to the distribution pad 108a at a first side (e.g., a proximal side) of the heater element 110, and a second end of the segment 112a opposing the first end may be electrically coupled and/or physically coupled to the connector segment 116a at a second side (e.g., a distal side) of the heater element 110 opposing the first side in the y-direction. A first end of the segment 112d may be electrically coupled and/or physically coupled to the connector segment 116a at the second side of the heater element 110, and a second end of the segment 112d opposing the first end may be electrically coupled and/or physically coupled to the connector segment 116c at the first side of the heater element 110. A first end of the segment 112c may be electrically coupled and/or physically coupled to the connector segment 116c at the first side of the heater element 110, and a second end of the segment 112c opposing the first end may be electrically coupled and/or physically coupled to the connector segment 116d at the first side of the heater element 110. A first end of the segment 112e may be electrically coupled and/or physically coupled to the connector segment 116d at the first side of the heater element 110, and a second end of the segment 112e opposing the first end may be electrically coupled and/or physically coupled to the connector segment 116b at the second side of the heater element 110. A first end of the segment 112b may be electrically coupled and/or physically coupled to the connector segment 116b at the second side of the heater element 110, and a second end of the segment 112b opposing the first end may be electrically coupled and/or physically coupled to the distribution pad 108b at the first side of the heater element 110.

The gap 114a may be located between the segments 112a and 112d, and between the segments 112b and 112e. The segments 112a and 112d may be curved segments that extend alongside each other. The segments 112b and 112e may be curved segments that extend alongside each other. The gap 114b may be located between the segments 112d and 112c, and between the segments 112e and 112c. The segment 112c maybe approximately C-shaped. The segment 112d and a first section of the segment 112c (e.g., a section 122) may extend alongside each other. The segment 112e and a second section of the segment 112c (e.g., a section 124) may extend alongside each other.

The gap 118 may be located between the connector segments 116a and 116b at the second side of the heater element 110. The gap 120 may be located between the connector segments 116c and 116d at the first side of the heater element 110.

As indicated above, FIG. 5 is provided as an example. Other examples may differ from what is described with regard to FIG. 5.

FIGS. 6A-6G are diagrams of example implementations of top view arrangements for an optical modulator structure 102 and a heater element 110 of an associated modulator heater structure 106 described herein. The example implementations illustrated in FIGS. 6A-6G include various top view top view shapes and arrangements of segments for the heater element 110, as well as various top view shapes for the optical modulator structure 102. The top view arrangements illustrated in FIGS. 6A-6G are some examples, and other top view arrangements are within the scope of the present disclosure. In general, some example implementations of top view arrangements include a heater element 110 having an overall top view shape that conforms to the top view shape of the optical modulator structure 102, and other example implementations of top view arrangements include a heater element 110 having an overall top view shape that differs from the top view shape of the optical modulator structure 102.

In an example implementation 600 in FIG. 6A, the overall top view shape of the heater element 110 is approximately circular and substantially conforms to the ring top view shape of the optical modulator structure 102. This is similar to the top view arrangement in FIGS. 1A and 1B, except that the arrangement of segments and connector segments in the example implementation 600 in FIG. 6A differs from the arrangement of segments and connector segments in the top view arrangement in FIGS. 1A and 1B.

In the example implementation 600 in FIG. 6A, the heater element 110 includes segments 112a-112e, gaps 114a and 114b, and connector segments 116a-116d. The segments 112a-112e may be curved segments and are included on one of the sides of the connector segment 116d in the x-direction. For example, the segments 112a and 112d may be included on a first sides the connector segment 116d, and the segments 112b, 112c, and 112d may be located on a second side of the connector segment 116d opposing the first side in the x-direction. The connector segment 116d may be a central connector segment of the heater element 110.

The connector segments 116a and 116b may be located on a first side of the connector segment 116d, and the connector segment 116c may be located on a second side of the connector segment 116d opposing the first side in the y-direction. The connector segment 116a may electrically couple the segments 112a and 112d, the connector segment 116b may electrically couple the segments 112b and 112d, the connector segment 116c may electrically couple the segments 112c and 112e, and the connector segment 116d may electrically couple the segments 112d and 112e.

The orientation of the heater element 110 illustrated in FIG. 6A is an example, and other orientations are within the scope of the present disclosure. The heater element 110 may be rotated relative to the optical modulator structure 102 (e.g., 90 degrees, 180 degrees) to enhance thermal efficiency of the heater element 110, to target heating of particular sections of the optical modulator structure 102, and/or to enable a particular spacing between the optical modulator structure and the optical waveguide structures 104a and/or 104b.

In an example implementation 602 in FIG. 6B, the overall top view shape of the heater element 110 is asymmetric, and only a portion of the top view shape of the heater element 110 substantially conforms to the ring top view shape of the optical modulator structure 102. For example, a first portion of the heater element 110 may have an approximately circular top view shape, and a second portion of the heater element 110 may have an approximately square top view shape. The first portion substantially conforms to the top view shape of the optical modulator structure 102, whereas the second portion does not conform to the top view shape of the optical modulator structure 102.

The orientation of the heater element 110 illustrated in FIG. 6B is an example, and other orientations are within the scope of the present disclosure. The heater element 110 may be rotated relative to the optical modulator structure 102 (e.g., 90 degrees, 180 degrees) to enhance thermal efficiency of the heater element 110, to target heating of particular sections of the optical modulator structure 102, and/or to enable a particular spacing between the optical modulator structure and the optical waveguide structures 104a and/or 104b.

In an example implementation 604 in FIG. 6C, the overall top view shape of the heater element 110 is approximately square and substantially conforms to the square top view shape of the optical modulator structure 102. The overall arrangement of segments and connector segments in the example implementation 604 in FIG. 6C may be similar to the arrangement of segments and connector segments in the top view arrangement in FIGS. 1A and 1B, except that the segments 112a-112c in the example implementation 604 in FIG. 6C are angular as opposed to being curved. In some implementations, two or more of the segments 112a-112c in the example implementation 604 in FIG. 6C are straight-lined segments that extend approximately parallel to each other.

The orientation of the heater element 110 illustrated in FIG. 6C is an example, and other orientations are within the scope of the present disclosure. The heater element 110 may be rotated relative to the optical modulator structure 102 (e.g., 90 degrees, 180 degrees) to enhance thermal efficiency of the heater element 110, to target heating of particular sections of the optical modulator structure 102, and/or to enable a particular spacing between the optical modulator structure and the optical waveguide structures 104a and/or 104b.

In an example implementation 606 in FIG. 6D, the overall top view shape of the heater element 110 is approximately square and does not conform to the triangular top view shape of the optical modulator structure 102. The optical modulator structure 102 may be oriented such that a corner of the triangular top view shape is facing the optical waveguide structure 104a and a side of the triangular top view shape is facing the optical waveguide structure 104b. Alternatively orientations for the triangular top view shape are within the scope of the present disclosure and may include opposing corners of the triangular top view shape facing the optical waveguide structures 104a and 104b, among other examples.

The orientation of the heater element 110 illustrated in FIG. 6D is an example, and other orientations are within the scope of the present disclosure. The heater element 110 may be rotated relative to the optical modulator structure 102 (e.g., 90 degrees, 180 degrees) to enhance thermal efficiency of the heater element 110, to target heating of particular sections of the optical modulator structure 102, and/or to enable a particular spacing between the optical modulator structure and the optical waveguide structures 104a and/or 104b.

In an example implementation 608 in FIG. 6E, the overall top view shape of the heater element 110 is approximately circular and does not conform to the rectangular top view shape of the optical modulator structure 102. The optical modulator structure 102 may be oriented such that corners of the rectangular top view shape are facing the optical waveguide structures 104a and 104b. Alternatively orientations for the triangular top view shape are within the scope of the present disclosure and may include opposing sides of the triangular top view shape facing the optical waveguide structures 104a and 104b, among other examples.

The orientation of the heater element 110 illustrated in FIG. 6E is an example, and other orientations are within the scope of the present disclosure. The heater element 110 may be rotated relative to the optical modulator structure 102 (e.g., 90 degrees, 180 degrees) to enhance thermal efficiency of the heater element 110, to target heating of particular sections of the optical modulator structure 102, and/or to enable a particular spacing between the optical modulator structure and the optical waveguide structures 104a and/or 104b.

In an example implementation 610 in FIG. 6F, the overall top view shape of the heater element 110 is approximately oval and substantially conforms to the oval top view shape of the optical modulator structure 102. The overall arrangement of segments and connector segments in the example implementation 610 in FIG. 6F may be similar to the arrangement of segments and connector segments in the top view arrangement in FIGS. 1A and 1B. Alternatively, the segments and connector segments in the example implementation 610 in FIG. 6F may have a different overall arrangement.

The orientation of the heater element 110 illustrated in FIG. 6F is an example, and other orientations are within the scope of the present disclosure. The heater element 110 may be rotated relative to the optical modulator structure 102 (e.g., 90 degrees, 180 degrees) to enhance thermal efficiency of the heater element 110, to target heating of particular sections of the optical modulator structure 102, and/or to enable a particular spacing between the optical modulator structure and the optical waveguide structures 104a and/or 104b.

In an example implementation 612 in FIG. 6G, the overall top view shape of the heater element 110 is approximately obround and substantially conforms to the obround top view shape of the optical modulator structure 102. The overall arrangement of segments and connector segments in the example implementation 612 in FIG. 6G may be similar to the arrangement of segments and connector segments in the top view arrangement in FIGS. 1A and 1B. Alternatively, the segments and connector segments in the example implementation 612 in FIG. 6G may have a different overall arrangement.

The orientation of the heater element 110 illustrated in FIG. 6G is an example, and other orientations are within the scope of the present disclosure. The heater element 110 may be rotated relative to the optical modulator structure 102 (e.g., 90 degrees, 180 degrees) to enhance thermal efficiency of the heater element 110, to target heating of particular sections of the optical modulator structure 102, and/or to enable a particular spacing between the optical modulator structure and the optical waveguide structures 104a and/or 104b.

As indicated above, FIGS. 6A-6G are provided as examples. Other examples may differ from what is described with regard to FIGS. 6A-6G.

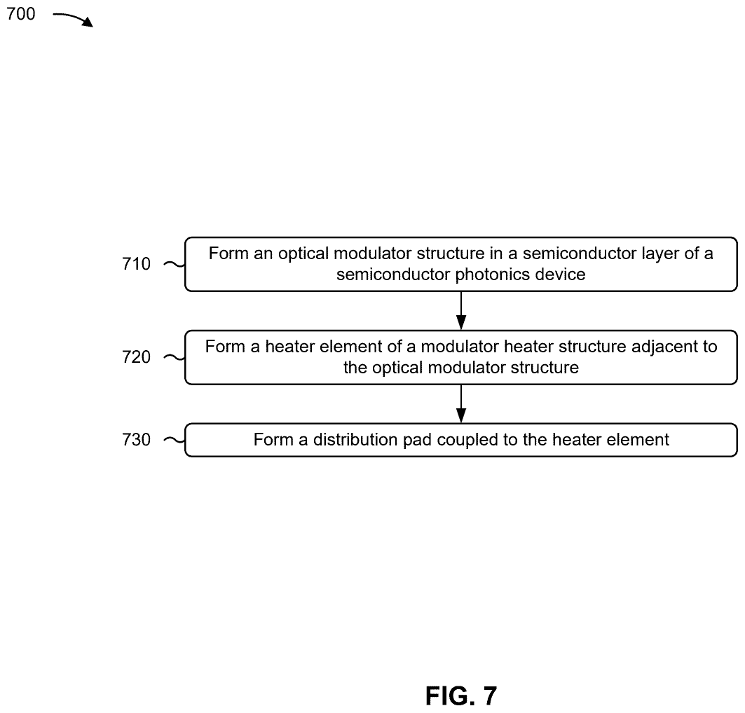

FIG. 7 is a flowchart of an example process 700 associated with forming a semiconductor photonics device described herein. In some implementations, one or more process blocks of FIG. 7 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 7, process 700 may include forming an optical modulator structure in a semiconductor layer of a semiconductor photonics device (block 710). For example, one or more semiconductor processing tools may be used to form an optical modulator structure (e.g., an optical modulator structure 102) in a semiconductor layer (e.g., a semiconductor layer 204) of a semiconductor photonics device (e.g., a semiconductor photonics device 100), as described herein.

As further shown in FIG. 7, process 700 may include forming a heater element of a modulator heater structure adjacent to the optical modulator structure (block 720). For example, one or more semiconductor processing tools may be used to form a heater element (e.g., a heater element 110) of a modulator heater structure (e.g., a modulator heater structure 106) adjacent to the optical modulator structure, as described herein. In some implementations, the heater element is formed to include a plurality of segments (e.g., two or more segments 112a-112e). In some implementations, the plurality of segments are concatenated by one or more connector segments (116a-116d) of the heater element. In some implementations, the plurality of segments are arranged in a plurality of sets of segments. In some implementations, one or more of the plurality of segments are curved segments. In some implementations, two or more of the plurality of segments are straight-lined segments that extend approximately parallel to each other.

As further shown in FIG. 7, process 700 may include forming a distribution pad coupled to the heater element (block 730). For example, one or more semiconductor processing tools may be used to form a distribution pad (e.g., a distribution pad 108a, a distribution pad 108b) coupled to the heater element, as described herein.

Process 700 may include additional implementations, such as any single implementation or any combination of implementations described below and/or in connection with one or more other processes described elsewhere herein.

In a first implementation, forming the heater element includes forming the heater element to conform to a top view shape of the optical modulator structure.

In a second implementation, alone or in combination with the first implementation, the top view shape of the optical modulator structure is at least one of an approximate ring shape, an approximate rectangle shape, an approximate triangle shape, an approximate obround shape, or an approximate ellipse shape.

In a third implementation, alone or in combination with one or more of the first and second implementations, forming the heater element includes forming the heater element such that the heater element is located below the optical modulator structure.

In a fourth implementation, alone or in combination with one or more of the first through third implementations, forming the heater element includes forming the heater element such that the heater element is located above the optical modulator structure.

In a fifth implementation, alone or in combination with one or more of the first through fourth implementations, forming the heater element includes forming the heater element such that the heater element laterally surrounds the optical modulator structure.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

In this way, a heater element of a modulator heater structure includes a plurality of segments. The segments of the heater element may be arranged in various configurations that conform to, or that are different from, the shape of the optical modulator structure. The segments of the heater element increase the effective length of the heater element and reduces a cross-sectional area of a current flow path through the heater element. The combination of the increased length and reduced cross-sectional area increases the resistance of the heater element, which enables the heater element to dissipate current more efficiently than a solid heater element. The increased thermal efficiency of the heater element enables the heater element to heat up more quickly and to generate heat more efficiently than a solid heater element. Thus, the increased thermal efficiency of the heater element enables the heater element to more efficiently stabilize the operating temperature of the optical modulator structure, which may increase the performance of the optical modulator structure.

As described in greater detail above, some implementations described herein provide a semiconductor photonics device. The semiconductor photonics device includes an optical modulator structure. The semiconductor photonics device includes a modulator heater structure adjacent to the optical modulator structure. The modulator heater structure includes a distribution pad and a heater element adjacent to the optical modulator structure and electrically coupled to the distribution pad. The heater element includes a plurality of segments, where at least a subset of the plurality of segments extend alongside each other.

As described in greater detail above, some implementations described herein provide a semiconductor photonics device. The semiconductor photonics device includes an optical modulator structure. The semiconductor photonics device includes a modulator heater structure adjacent to the optical modulator structure. The modulator heater structure includes a plurality of distribution pads and a heater element adjacent to the optical modulator structure and electrically coupled to the plurality of distribution pads. The heater element includes a first curved segment, a second curved segment, and a third curved segment electrically coupled to the first curved segment and electrically coupled to the second curved segment. A first section of the third curved segment extends alongside the first curved segment, and a second section of the third curved segment extends alongside the second curved segment.

As described in greater detail above, some implementations described herein provide a method. The method includes forming an optical modulator structure in a semiconductor layer of a semiconductor photonics device. The method includes forming a heater element of a modulator heater structure adjacent to the optical modulator structure, where the heater element is formed to include a plurality of segments, where the plurality of segments are concatenated by one or more connector segments of the heater element. The method includes forming a distribution pad coupled to the heater element.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
an optical modulator structure; and
a modulator heater structure, adjacent to the optical modulator structure, comprising:
a distribution pad; and
a heater element, adjacent to the optical modulator structure and electrically coupled to the distribution pad,
wherein the heater element comprises a plurality of segments, and
wherein at least a subset of the segments extend alongside each other.

2. The semiconductor photonics device of claim 1, wherein the plurality of segments comprises:
a first segment having a first end that is electrically coupled to the distribution pad; and
a second segment,
wherein a second end of the first segment, opposing the first end, is electrically coupled to the second segment.

3. The semiconductor photonics device of claim 2, wherein the second end of the first segment is physically coupled to a connector segment that connects the first segment and the second segment.

4. The semiconductor photonics device of claim 2, wherein the plurality of segments comprises:
a third segment,
wherein the second end of the first segment is electrically coupled to a third end of the second segment, and
wherein a fourth end of the second segment opposing the third end is electrically coupled to the third segment.

5. The semiconductor photonics device of claim 4, wherein the third end of the second segment is physically coupled to a first connector segment that connects the first segment and the second segment; and
wherein the fourth end of the second segment is physically coupled to a second connector segment that connects the second segment and the third segment.

6. The semiconductor photonics device of claim 5, wherein the first connector segment is located on a first side of the heater element; and
wherein the second connector segment is located at a second side of the heater element opposing the first side.

7. A semiconductor photonics device, comprising:
an optical modulator structure; and
a modulator heater structure, adjacent to the optical modulator structure, comprising:
a plurality of distribution pads; and
a heater element, adjacent to the optical modulator structure and electrically coupled to the plurality of distribution pads, comprising:
a first curved segment;
a second curved segment; and
a third curved segment electrically coupled to the first curved segment and electrically coupled to the second curved segment,
wherein a first section of the third curved segment extends alongside the first curved segment, and
wherein a second section of the third curved segment extends alongside the second curved segment.

8. The semiconductor photonics device of claim 7, wherein the first curved segment is electrically coupled to a first distribution pad, of the plurality of distribution pads, at a first end of the first curved segment; and
wherein the second curved segment is electrically coupled to a second distribution pad, of the plurality of distribution pads, at a second end of the second curved segment.

9. The semiconductor photonics device of claim 8, wherein the third curved segment is electrically coupled to a third end of the first curved segment and electrically coupled to a fourth end of the second curved segment.

10. The semiconductor photonics device of claim 8, wherein the first curved segment is mirrored relative to the second curved segment.

11. The semiconductor photonics device of claim 10, wherein the first section of the third curved segment extends alongside the first curved segment; and
wherein the second section of the third curved segment extends alongside the second curved segment.

12. The semiconductor photonics device of claim 8, wherein the heater element further comprises:
a fourth curved segment extending alongside the first curved segment and electrically coupled to the first curved segment and a first distribution pad of the plurality of distribution pads.

13. The semiconductor photonics device of claim 12, wherein the heater element further comprises:
a fifth curved segment extending alongside the second curved segment and electrically coupled to the second curved segment and a second distribution pad of the plurality of distribution pads.

14. The semiconductor photonics device of claim 7, wherein the first curved segment and the third curved segment are electrically coupled together by a first connector segment of the heater element;
wherein the second curved segment and the third curved segment are electrically coupled together by a second connector segment of the heater element;
wherein the first connector segment and the second connector segment are spaced apart by a gap; and
wherein the gap is located at a first side of the heater element opposing a second side of the heater element at which the heater element is electrically coupled to the plurality of distribution pads.

15. A method, comprising:
forming an optical modulator structure in a semiconductor layer of a semiconductor photonics device;
forming a heater element of a modulator heater structure adjacent to the optical modulator structure,
wherein the heater element is formed to include a plurality of segments, and
wherein the plurality of segments are concatenated by one or more connector segments of the heater element; and
forming a distribution pad coupled to the heater element.

16. The method of claim 15, wherein forming the heater element comprises:
forming the heater element to conform to a top view shape of the optical modulator structure.

17. The method of claim 16, wherein the top view shape of the optical modulator structure is at least one of:
an approximate ring shape,
an approximate rectangle shape,
an approximate triangle shape,
an approximate obround shape, or
an approximate ellipse shape.

18. The method of claim 15, wherein forming the heater element comprises:
forming the heater element such that the heater element is located below the optical modulator structure.

19. The method of claim 15, wherein forming the heater element comprises:
forming the heater element such that the heater element is located above the optical modulator structure.

20. The method of claim 15, wherein forming the heater element comprises:
forming the heater element such that the heater element laterally surrounds the optical modulator structure.
